(19) United States
(12) Patent Application Publication
(10) Pub. No.: US 2009/0060064 A1
(43) Pub. Date: Mar. 5, 2009

(54) OFDM Communication System, Method for Generating Feedback Information Thereof, and Communication Apparatus

(75) Inventors: Hisashi Futaki, Tokyo (JP); Yoshikazu Kakura, Tokyo (JP); Shousei Yoshida, Tokyo (JP); Takumi Ito, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/887,831

(22) PCT Filed: Apr. 4, 2006
(86) PCT No.: PCT/JP2006/307089

§ 371 Date: Oct. 4, 2007

(30) Foreign Application Priority Data
Apr. 4, 2005 (JP) 2005-107510

(51) Int. Cl. H04L 27/28; H04J 11/00

(52) U.S. Cl. 375/260; 370/208

(57) ABSTRACT

An OFDM communication system which performs appropriate feedback flexibly adapted to channel states, while suppressing an amount of feedback information. The OFDM communication system has first and second communication apparatuses. In a second receiver of the second communication apparatus, a channel quality measurement part measures channel quality for each of sub-carriers. A time variation measurement part and a frequency measurement part respectively measure variation of channel quality in a time domain and a frequency domain, respectively, and output the variation of channel quality as time variation information and frequency variation information, also respectively. Based on the measured time variation information and frequency variation information, a two-dimensional control part performs two-dimensional blocking for forming two-dimensional blocks each from plural adjacent sub-carriers which are adjacent to each other in the time domain and the frequency domain. The two-dimensional control part measures and outputs channel quality of each two-dimensional block, as feedback information.

### TECHNICAL FIELD

The present invention relates to an OFDM communication system which feeds back channel information, adaptively corresponding to channel states, and a method for generating feedback information thereof.

### BACKGROUND ART

OFDM (Orthogonal Frequency Division Multiplexing: orthogonal frequency division multiplexing) is a multi-carrier communication scheme for transmitting/receiving information data carried on a signal multiplexing a number of sub-carriers. According to the OFDM, parameters are designed so that channels are coherent in units of sub-carriers while channel characteristics usually differ between sub-carriers. Therefore, the characteristics can be improved by generating feedback information for each sub-carrier, based on channel information as a result of estimating a channel, and by further feeding back the feedback information to the transmitter side. However, increase in the amount of feedback information accompanies decrease in the data transmission efficiency.

In a conventional method capable of reducing the amount of feedback information, sub-carrier grouping is carried out for each OFDM symbol to group a plurality of fixed sequential sub-carriers into one group. Channel quality is averaged in units of sub-carrier groups and then fed back.

Referring to FIG. 30, the following description will be made of an OFDM communication system in which feedback information is generated in units of fixed sub-carrier groups and is fed back at fixed timing.

In a first communication apparatus 301 of a first transmitter 303, an OFDM signal generating part 107 is input with information data S_{TDAT} and control information S_{CTRL} and groups a plurality of fixed sequential sub-carriers into one sub-carrier group. The OFDM signal generating part 107 carries out link adaptation, sets transmission parameters for each sub-carrier group, and generates a transmitted OFDM signal S_{TX}.

In a second receiver 305 of a second communication apparatus 302, an information reproducing part 109 is input with a received OFDM signal S_{RX} and outputs reproduction information data S_{RDAT} and channel information S_{CEO} corresponding to information data.

A channel quality measurement part 110 is input with the channel information S_{CEO}, measures channel quality for each sub-carrier, and outputs the quality as channel quality information S_{CEQO}.

A feedback quality generating part 307 is input with the channel quality information S_{CEQO}, groups fixed sub-carriers, averages channel quality in units of sub-carrier groups, and outputs results as feedback information S_{TFBO} A second transmitter 306 of the second communication apparatus 302 generates a transmitted feedback signal S_{FBTX} from the feedback information S_{TFBO}, and feeds back the transmitted feedback signal S_{FBTX} at fixed timing to the first communication apparatus 301.

The first receiver 304 of the first communication apparatus 301 generates reproduced feedback information S_{RFBO} corresponding to the feedback information S_{TFBO} from a received feedback signal S_{FBRX}. An adaptive control part 108 of the first transmitter 303 reproduces channel quality for each sub-carrier group and generates control information S_{CTRL}.

The amount of feedback information can be reduced by generating feedback information in units of sub-carrier groups in accordance with operations as described above.

The adaptive control part 108 generates information for carrying out adaptive control, transmission power control, or the like. The adaptive control is to perform symbol mapping so that the higher the channel quality in a sub-carrier group, the greater the modulation multiple-valued number of a symbol assigned to a sub-carrier belonging to the sub-carrier group. The transmission power control is to increase electric power allocated to sub-carriers belonging to a sub-carrier group as the channel quality of the sub-carrier group decreases lower.

Patent Document 1: JP-A-2004-104775

Patent Document 2: JP-A-2005-27107

### DISCLOSURE OF THE INVENTION

### Problems to be Solved by the Invention

According to the background art as described above, grouping of fixed sub-carrier groups is constantly performed within a frequency domain. Feedback is carried out constantly at fixed timing within a time domain. Therefore, in order to cope with both cases that the channel quality varies fast in the frequency domain and that the channel quality varies fast in the time domain, the number of sub-carriers n per sub-carrier group (where n is an integer not smaller than 2) needs to be sufficiently small and feedback needs to be performed at a sufficiently short time interval. Consequently, a problem arises in that the amount of feedback information increases in proportion to the number of sub-carriers n per sub-carrier group and in inverse proportion to the time interval to perform feedback.

The present invention has been made on the background as described above and has an object of providing an OFDM communication system which flexibly performs feedback of channel information in accordance with channel states, taken into consideration variation of channel quality in two-dimensional fields of a time domain and a frequency domain.

### Means for Solving the Problems

According to one aspect of the present invention to achieve the above object, there is provided an OFDM communication system comprising: a first communication apparatus including a first transmitter and a first receiver; and a second communication apparatus including a second transmitter and a second receiver. The first receiver is configured to output reproduced feedback information, based on a received feedback signal corresponding to a transmitted feedback signal sent from the second transmitter. The first transmitter includes an adaptive control part configured to output control information based on the reproduced feedback information, and an OFDM signal generating part configured to generate a transmitted OFDM signal in which one frame is constituted of F OFDM symbols (where F is an integer not smaller than 1) each consisting of N sub-carriers (where N is an integer not smaller than 2), based on information data and the control information. The second receiver includes an information reproducing part configured to output reproduced information data corresponding to the information data and channel information, based on a received OFDM signal corresponding to the transmitted OFDM signal sent from the first transmitter, a channel quality measurement part configured to measure channel quality, based on the channel information, and outputs a measurement result thereof as channel quality information, and a feedback control part configured to output, as feedback information, information concerning channel quality obtained by considering variation of the channel quality in two-dimensional fields of a time domain and a frequency domain, based on the channel quality information, and by adaptively controlling resolutions in the time domain and the frequency domain. The second transmitter is configured to output the transmitted feedback signal, based on the feedback information.

Preferably, the feedback control part may include: a time variation measurement part configured to measure variation of the channel quality in the time domain, based on the channel quality information, and outputs a measurement result thereof as time variation information; a frequency variation measurement part which measures variation of the channel quality in the frequency domain, based on the channel quality information, and to output a measurement result thereof as frequency variation information; and a feedback information generating part configured to output the feedback information, based on the channel quality information, the time variation information, and the frequency variation information.

Preferably, the feedback information generating part may include a two-dimensional control part configured to set the numbers n and j of sub-carriers per two-dimensional block respectively in the time domain and the frequency domain (where j and n are respectively divisors of J and N and J=F×G is given), in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and frequency variation information, and to output the numbers n and j of sub-carriers, as two-dimensional control information, and a feedback quality generating part configured to measure channel quality in each of total L two-dimensional blocks (where L=K×M, K=J/j, and M=N/n), based on the channel quality information and the two-dimensional control information, and outputs a measurement result thereof as feedback quality information. The feedback information generating part may be configured to output the two-dimensional control information and the feedback quality information, as the feedback information.

Preferably, the feedback information generating part may include: a two-dimensional control part configured to set the numbers n and j of sub-carriers per two-dimensional block respectively in the time domain and the frequency domain (where j and n are respectively divisors of J and N, and are multiplied by each other to give a constant product i.e. j×n=P, and J=F×G is given), under a condition that a total number L of two-dimensional blocks (where L is a divisor of Q and Q=N×J is given) and a number P of sub-carriers per two-dimensional block (where P=Q/L) are maintained constant, in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and frequency variation information, and to output the numbers n and j of sub-carriers, as two-dimensional control information; and a feedback quality generating part configured to measure channel quality in each of total L two-dimensional blocks, based on the channel quality information and the two-dimensional control information, and to output a measurement result thereof as feedback quality information. The feedback information generating part may be configured to output the two-dimensional control information and the feedback quality information, as the feedback information.

Preferably, the time variation measurement part may be configured to measure an amount of variation of channel quality between adjacent sub-carriers in the time domain, and to output a measurement result thereof as the time variation information, and the frequency variation measurement part is configured to measure a variation amount of channel quality between adjacent sub-carriers in the frequency domain, and to output a measurement result thereof as the frequency variation information.

Preferably, the time variation measurement part may be configured to measure variance of channel quality in the time domain, and to output a measurement result thereof as the time variation information, and the frequency variation measurement part is configured to measure variance of channel quality in the frequency domain, and to output a measurement result thereof as the frequency variation information.

Preferably, the two-dimensional control part may be configured to set the number j of sub-carriers per two-dimensional block in the time domain in inverse proportion to the time variation information, and to set the number n of sub-carriers per two-dimensional block in the frequency domain in inverse proportion to the frequency variation information.

Preferably, the feedback quality generating part may be configured to average channel quality of total P sub-carriers in each of the L two-dimensional blocks, and to output an averaged result as the feedback quality information.

Preferably, the two-dimensional control part may be configured to determine variation of the channel quality in the two-dimensional fields of the time domain and the frequency domain, in arbitrary time equivalent to X frames (where X is a natural number), determines an OFDM block length based on the time variation information, thereafter to perform two-dimensional blocking based on the time variation information and the frequency variation information, and to output the two-dimensional control information.

Preferably, the feedback quality generating part may be configured to output the feedback quality information, based on the two-dimensional control information generated in previously transmitted B OFDM blocks (where B is a natural number).

Preferably, the two-dimensional control part may be configured to sequentially determine variation of channel quality in the two-dimensional fields of the time domain and the frequency domain, in units of arbitrary time in one OFDM block, performs two-dimensional blocking based on the time variation information and the frequency variation information, and to output the two-dimensional control information.

Preferably, the feedback quality generating part may be configured to, under a condition that an amount of all feedback information is maintained constant in each one OFDM block, generate the feedback quality information by adaptively controlling an amount of feedback information fed back at a time and a feedback frequency indicating the number of times by which feedback is carried out in the time domain in one OFDM block unit.

Preferably, the feedback quality generating part may be configured to generate the feedback quality information under a condition that an amount of feedback information fed back at a time and a feedback frequency indicating the number of times by which feedback is carried out in the time domain in one OFDM block unit are maintained constant.

Preferably, the feedback quality generating part may be configured to generate the feedback quality information by time-dividing channel quality of each L/K two-dimensional blocks into feedback information equivalent to Kmax/K times, in OFDM symbols from ((i−1)×j+1)-th OFDM symbol to (i×j)-th OFDM symbol (where i=1, 2, 3, . . . , K), so that the feedback frequency in each OFDM block is maintained at a maximum value Kmax of K (where Kmax=J/jmin: Jmin is an arbitrary minimum value of j) and so that the amount of feedback information fed back at a time is maintained at channel quality equivalent to L/Kmax two-dimensional blocks.

Preferably, the feedback information generating part may include: a two-dimensional control part configured to set the numbers n and j of sub-carriers per two-dimensional block respectively in the time domain and the frequency domain (where j and n are respectively divisors of J and N and are multiplied by each other to give a constant product (j×n=P), and J=F×G is given), under a condition that a total number L of two-dimensional blocks (where L is a divisor of Q and Q=N×J is given) and a number P of sub-carriers per two-dimensional block (where P=Q/L) are maintained constant, in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and frequency variation information, and to output the numbers n and j of sub-carriers, as two-dimensional control information; and a polynomial approximation part configured to approximate variation of channel quality to a polynomial, based on the channel quality information and the two-dimensional control information, and to output coefficients of the polynomial, inflection points thereof, and channel quality at the inflection points, or only the coefficients, as feedback quality information. The feedback information generating part may be configured to output the two-dimensional control information and the feedback quality information, as the feedback information.

Preferably, the polynomial approximation part may be configured to approximate variation of channel quality in either the time domain or the frequency domain in each of L two-dimensional blocks to one polynomial, and if the variation of channel quality in the time domain is approximated to a polynomial, a t-th sub-carrier (where t is an arbitrary integer between 1 to n) among sub-carriers which belong to each of j OFDM symbols is selected from every T-th OFDM symbol in order from a first OFDM symbol (where T is an arbitrary integer between 0 and j−2), and variation of channel quality throughout the selected sub-carriers is approximated to one polynomial, or if the variation of channel quality in the frequency domain is approximated to a polynomial, every S-th sub-carrier (where S is an arbitrary integer between 0 and n−2) is selected in order from a first sub-carrier among sub-carriers which belong to an s-th OFDM symbol (where s is an arbitrary integer between 1 to j), and variation of channel quality throughout the selected sub-carriers is approximated to one polynomial.

Preferably, the polynomial approximation part may be configured to: average channel quality of total P sub-carriers in each of L two-dimensional blocks; approximate variation of channel quality throughout every adjacent K two-dimensional blocks in the time domain to u polynomials (where u is an arbitrary integer between 0 and K−1); and approximate variation of channel quality throughout every adjacent M two-dimensional blocks in the frequency domain to v polynomials (where v is an arbitrary integer between 0 and M−1).

Preferably, the polynomial approximation part may be configured to arbitrarily preset a maximum number w of polynomials to be approximated to (where w=u×M+v×K). Also preferably, the polynomial approximation part arbitrarily presets a maximum order of polynomials to be approximated to. Also preferably, the polynomial approximation part is configured to approximate variation of channel quality according to a least squares method or Lagrange interpolation method.

Preferably, the channel quality measurement part may be configured to use, as channel quality, a SIR (Signal-to-Interference Ratio: ratio between desired signal power and interference signal power) or a channel gain.

According to another aspect of the present invention, there is provided a feedback information generation method for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the method comprising: a step of measuring variation of channel quality in each of sub-carriers constituting the received OFDM signal; a step of measuring variation of channel quality in each of a time domain and a frequency domain, based on the measured channel quality; a step of two-dimensional blocking sub-carriers adjacent to each other in the time domain and in the frequency domain, based on the measured variation of channel quality in each of the time domain and the frequency domain; and a step of generating the feedback information, based on the result of the two-dimensional blocking and the channel quality.

According to still another aspect of the present invention, there is provided a feedback information generation program for a communication apparatus for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the program causing a computer to execute: a process of measuring variation of channel quality in each of the time domain and the frequency domain, using channel quality information which indicates channel quality of each of sub-carriers constituting the received OFDM signal; a process of two-dimensional blocking sub-carriers adjacent to each other in the time domain and in the frequency domain, based on the measured variation of channel quality in each of the time domain and the frequency domain; and a process of generating the feedback information, using a result of measuring variation of channel quality in each of the time domain and the frequency domain.

According to still another aspect of the present invention, there is provided a communication apparatus for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the apparatus comprising: first measurement means for measuring variation of channel quality in each of sub-carriers constituting the received OFDM signal; second measurement means for measuring variation of channel quality in each of a time domain and a frequency domain, based on the channel quality measured by the first measurement part; means for two-dimensional blocking sub-carriers adjacent to each other in the time domain and in the frequency domain, based on the variation of channel quality in each of the time domain and frequency domain, which is measured by the second measurement means; and feedback information generation means for generating the feedback information, based on the result of the two-dimensional blocking and the channel quality.

### ADVANTAGES OF THE INVENTION

The present invention is advantageous in that appropriate feedback can be performed flexibly adapted to channel states, while suppressing information amount. This is because two-dimensional blocking is performed depending on channel states, in consideration of variation of channel quality in each of time and frequency domains.

### BRIEF DESCRIPTION OF DRAWINGS

FIG. 1 shows a structure of an OFDM communication system according to first to fourth examples of the present invention;

FIG. 2 shows a structure of an OFDM communication system according to a fifth example of the present invention;

FIG. 3 graphically shows a method for measuring Doppler frequency in the first to fifth examples of the present invention;

FIG. 4 graphically shows a method for measuring delay spread in the first to fifth examples of the present invention;

FIG. 5 graphically shows indices in a time domain, which are used for two-dimensional blocking in the first to fifth examples of the present invention;

FIG. 6 graphically shows indices in a frequency domain, which are used for two-dimensional blocking in the first to fifth examples of the present invention;

FIG. 7 graphically shows two-dimensional blocking in the first example of the present invention;

FIG. 8 graphically shows two-dimensional blocking in the first example of the present invention;

FIG. 9 graphically shows a feedback method in the first example of the present invention;

FIG. 10 graphically shows two-dimensional blocking in the second example of the present invention;

FIG. 11 graphically shows two-dimensional blocking in the second example of the present invention;

FIG. 12 graphically shows a feedback method in the second example of the present invention;

FIG. 13 graphically shows a feedback method in the second example of the present invention;

FIG. 14 graphically shows two-dimensional blocking in the second example of the present invention;

FIG. 15 graphically shows two-dimensional blocking in the second example of the present invention;

FIG. 16 graphically shows a feedback method in the second example of the present invention;

FIG. 17 graphically shows a feedback method in the second example of the present invention;

FIG. 18 graphically shows two-dimensional blocking in the third example of the present invention;

FIG. 19 graphically shows two-dimensional blocking in the third example of the present invention;

FIG. 20 graphically shows a feedback method in the third example of the present invention;

FIG. 21 graphically shows two-dimensional blocking in the fourth example of the present invention;

FIG. 22 graphically shows a feedback method in the fourth example of the present invention;

FIG. 23 graphically shows two-dimensional blocking in the fourth example of the present invention;

FIG. 24 graphically shows a feedback method in the fourth example of the present invention;

FIG. 25 graphically shows two-dimensional blocking in the fourth example of the present invention;

FIG. 26 graphically shows a feedback method in the fourth example of the present invention;

FIG. 27 graphically shows two-dimensional blocking in the fifth example of the present invention;

FIG. 28 graphically shows two-dimensional blocking in the fifth example of the present invention;

FIG. 29 graphically shows a feedback method in the fifth example of the present invention; and

FIG. 30 graphically shows an OFDM communication system according to the prior art.

### EXPLANATION OF REFERENCE SYMBOLS

101, 201, 301: First communication apparatus
102, 202, 302: Second communication apparatus
103, 203, 303: First transmitter
104, 204, 304: First receiver
105, 205, 305: Second receiver
106, 206, 306: Second transmitter
107: OFDM signal generating part
108: Adaptive control part
109: Information reproducing part
110: Channel quality measurement part
111: Time variation measurement part
112: Frequency variation measurement part
113: Two-dimensional control part
114, 307: Feedback quality generating part
207: Polynomial approximation part

### BEST MODE FOR CARRYING OUT THE INVENTION

Hereinafter, exemplary embodiments of an OFDM communication system, a feedback information generation method thereof, and a communication apparatus according to the present invention will be described with reference to drawings.

### FIRST EXEMPLARY EMBODIMENT

The OFDM communication system according to an embodiment of the present invention is constituted by a first communication apparatus including a first transmitter and a first receiver, as well as a second communication apparatus including a second receiver and a second transmitter. One frame consists of F OFDM symbols (where F is an integer not smaller than 1) each consisting of N sub-carriers (where N is an integer not smaller than 2).

In the structure as described above, channel quality information is defined as a result of measuring channel quality based on channel information by the second receiver of the second communication apparatus. Time variation information and frequency variation information are defined as results of measuring variation of channel quality within a time domain and a frequency domain, respectively.

Based on the time variation information and the frequency variation information, two-dimensional blocking is performed so as to divide one OFDM block consisting of G frames (where G is an integer not smaller than 1) into two-dimensional blocks each consisting of total P sub-carriers (where P=j×n) consisting of j×n sub-carriers (where j and n are respectively divisors of J and N and J=F×G) each having substantially almost same channel quality to that of adjacent sub-carriers in the time domain and the frequency domain. The numbers j and n of sub-carriers per two-dimensional block respectively in the time domain and the frequency domain are taken as two-dimensional control information.

Results obtained by measuring channel quality on the basis of the channel quality information and the two-dimensional control information are feedback quality information. The two-dimensional control information and the feedback quality information constitute feedback information. In this manner, feedback is performed, adapted to channel states.

### SECOND EXEMPLARY EMBODIMENT

An OFDM communication system according to the present embodiment is constituted by a first communication apparatus including a first transmitter and a first receiver, as well as a second communication apparatus including a second receiver and a second transmitter. One frame consists of F OFDM symbols (where F is an integer not smaller than 1) each consisting of N sub-carriers (where N is an integer not smaller than 2). This embodiment feeds back channel quality information in accordance with channel states, with the amount of feedback information maintained constant. Therefore, under a condition that the total number of two-dimensional blocks should be constant, feedback is carried out, adaptively controlling resolution of feedback quality information in each of the time domain and the frequency domain.

In the OFDM communication system according to the present embodiment, results of measuring channel quality on the basis of channel information by the second receiver of the second communication apparatus are taken as channel quality information. Results of measuring variation of the channel quality in a time domain and a frequency domain on the basis of the channel quality information are time variation information and frequency variation information.

Based on the time variation information and the frequency variation information, the numbers j and n of sub-carriers per two-dimensional block in the time domain and the frequency domain are set respectively, wherein the total number L of two-dimensional blocks (where L=K×M, K=J/j, and M=N/n) and the number P of sub-carriers per two-dimensional block are maintained constant respectively. Thus, the set numbers j and n of sub-carriers are referred to as two-dimensional control information.

Results of measuring the channel quality in each two-dimensional block on the basis of the channel quality information and the two-dimensional control information are feedback quality information. The two-dimensional control information and the feedback quality information are feedback information. In this manner, feedback is performed in accordance with channel states.

### THIRD EXEMPLARY EMBODIMENT

An OFDM communication system according to the present embodiment is constituted by a first communication apparatus including a first transmitter and a first receiver, as well as a second communication apparatus including a second receiver and a second transmitter. One frame consists of F OFDM symbols (where F is an integer not smaller than 1) each consisting of N sub-carriers (where N is an integer not smaller than 2). This embodiment feeds back channel quality information in accordance with channel states, with the amount of feedback information maintained constant. Therefore, under a condition that the total number of two-dimensional blocks should be constant, feedback is carried out, adaptively controlling resolution of feedback quality information in each of the time domain and the frequency domain.

In the OFDM communication system according to the present embodiment, results of measuring channel quality on the basis of channel information by the second receiver of the second communication apparatus are taken as channel quality information. Results of measuring variation of the channel quality in a time domain and a frequency domain on the basis of the channel quality information are time variation information and frequency variation information.

Based on the time variation information and the frequency variation information, the numbers j and n of sub-carriers per two-dimensional block in the time domain and the frequency domain are set respectively, wherein the total number L of two-dimensional blocks and the number P of sub-carriers per two-dimensional block are maintained constant respectively. Thus, the set numbers j and n of sub-carriers are referred to as two-dimensional control information.

Based on the channel quality information and the two-dimensional control information, variation of the channel quality is approximated to a polynomial. Coefficients of the polynomial, inflection points thereof, and channel quality at the inflection points, or only the coefficients are taken as feedback quality information. The two-dimensional control information and the feedback quality information are feedback information. In this manner, feedback is performed in accordance with channel states.

As described above, according to the present embodiments, feedback of channel information can be carried out in accordance with states of channel quality, suppressing the amount of feedback information.

Next, the embodiments of the present invention will be described in details with reference to the drawings.

### FIRST EXAMPLE

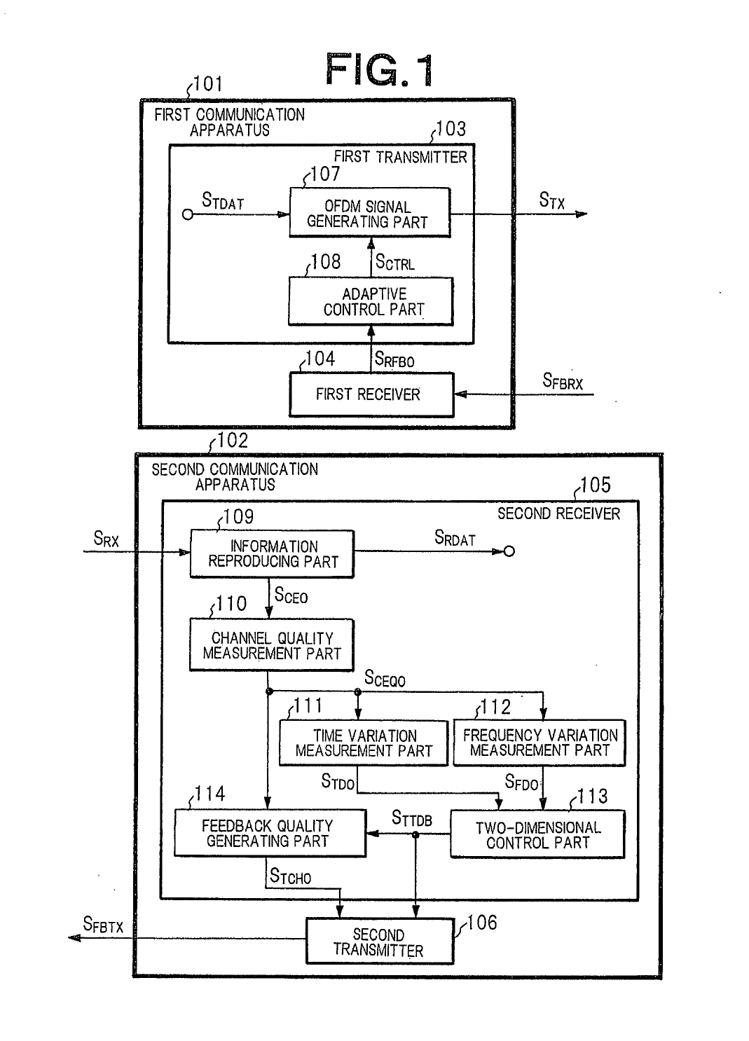

FIG. 1 is a block diagram showing a structure of an OFDM communication system according to the first example of the present invention (which also applies to the second to fourth examples below). In this example, one frame consists of F OFDM symbols (where F is an integer not smaller than 1) each consisting of N sub-carriers (where N is an integer not smaller than 2). Also in this example, two-dimensional blocks are numbered consecutively in order from the two-dimensional block to which an OFDM symbol assigned with the youngest number and a sub-carrier assigned with the youngest number belong in each OFDM block consisting of G frames (where G is an integer not smaller than 1).

In FIG. 1, the OFDM communication system according to this example includes a first communication apparatus 101 having a first transmitter 103 and a first receiver 104, and a second communication apparatus 102 having a second receiver 105 and a second transmitter 106. The first communication apparatus 101 and the second communication apparatus 102 are constituted, for example, by a base station and a mobile station.

In the first communication apparatus 101, the first transmitter 103 has an OFDM signal generating part 107 and an adaptive control part 108.

The adaptive control part 108 is input with reproduced feedback information S_{RFBO}, and outputs control information S_{CTRL} to the OFDM signal generating part 107, based on the reproduced feedback information S_{RFBO}.

The OFDM signal generating part 107 is input with information data S_{TDAT} and the control signal information S_{CTRL} from the adaptive control part 108. Based on the S_{TDAT} and S_{CTRL} the OFDM signal generating part 107 performs sub-carrier grouping in a manner that every nt adjacent sub-carriers (where nt is a divisor of N determined by the reproduced feedback information S_{RFBO}) orderly from the first sub-carrier among N sub-carriers are grouped into a sub-carrier group assigned to a sub-carrier group number m (where m=1, 2, . . . , M, and M=N/n). Further, the OFDM signal generating part 107 performs link adaptation to set transmission parameters for each sub-carrier group, and generates and transmits a transmitted OFDM signal S_{TX} to the second communication apparatus 102.

In the second communication apparatus 102, the second receiver 105 has an information reproducing part 109, a channel quality measurement part 110, a time variation measurement part 111, a frequency variation measurement part 112, a two-dimensional control part 113, and a feedback quality generating part 114.

The information reproducing part 109 is input with a received OFDM signal S_{RX} corresponding to a transmitted OFDM signal S_{TX} from the first communication apparatus 101. Based on the received OFDM signal, the information reproducing part 109 outputs reproduction information data S_{RDAT} corresponding to information data S_{RDAT}, and outputs channel information S_{CEO} to the channel quality measurement part 110.

The channel quality measurement part 110 is input with the channel information S_{CEO} from the information reproducing part 109. Based on this information, the channel quality measurement part 110 measures channel quality for each sub-carrier, and outputs measured results, as channel quality information S_{CEQO}, to each of the time variation measurement part 111, frequency variation measurement part 112, and feedback quality generating part 114.

The time variation measurement part 111 is input with the channel quality information S_{CEQO} from the channel quality measurement part 110. Based on this information, the time variation measurement part 111 measures variation of the channel quality in a time domain, and outputs a measured result, as time variation information S_{TDO}, to the two-dimensional control part 113.

The frequency variation measurement part 112 is input with the channel quality information S_{CEQO} from the channel quality measurement part 110. Based on this information, the frequency variation measurement part 112 measures variation of the channel quality in a frequency domain, and outputs a measured result, as frequency variation information S_{FDO}, to the two-dimensional control part 113.

The two-dimensional control part 113 is input with the time variation information S_{TDO} and the frequency variation information S_{FDO} respectively from the time variation measurement part 111 and the frequency variation measurement part 112. Based on these pieces of information, the two-dimensional control part 113, the two-dimensional control part 113 performs two-dimensional blocking so that one OFDM block consisting of G frames (where G is an integer not smaller than 1) is divided into two-dimensional blocks each consisting of plural sub-carriers which are adjacent to each other in each of the time domain and the frequency domain. The two-dimensional control part 113 outputs the number of sub-carriers per two-dimensional block in each of the time domain and the frequency domain, as two-dimensional control information S_{TTDB}, to the feedback quality generating part 114.

The feedback quality generating part 114 is input with the channel quality information S_{CEQO} from the channel quality measurement part 110 and the two-dimensional control information S_{TTDB} from the two-dimensional control part 113. Based on these pieces of information, the feedback quality generating part 114 measures channel quality, and outputs a measured result, as feedback quality information S_{TCHO} to the second transmitter 106.

The second transmitter 106 is input with the feedback quality information S_{TCHO} from the feedback quality generating part 114 and the two-dimensional control information S_{TTDB} from the two-dimensional control part 113. Based on these pieces of information, the second transmitter 106 generates and transmits a transmitted OFDM signal S_{FBTX} to the first communication apparatus 101.

The first receiver 104 is input with a received feedback signal S_{FBRX} corresponding to the transmitted feedback signal S_{FBTX} from the second communication apparatus 102. Based on this signal, the first receiver 104 outputs reproduced feedback information S_{RFBO} corresponding to feedback information, to the control part 108.

By the operation as described above, channel information is fed back from the second communication apparatus 102 to the first communication apparatus 101, in accordance with of channel states therebetween.

The feedback quality generating part 114 averages channel quality over all sub-carriers in each of two-dimensional blocks, and takes averaged results as feedback quality information.

In this example, the time variation measurement part 111 calculates coherent time C_{T} (where C_{T} is a real number not smaller than 0) in which adjacent sub-carriers in the time domain are regarded as having substantially constant channel quality. The time variation measurement part 111 outputs the calculated C_{T} as time variation information S_{TDO} to the two-dimensional control part 113. The frequency variation measurement part 112 calculates a coherent bandwidth C_{BW} (where C_{BW} is a real number not smaller than 0) in which adjacent sub-carriers in the frequency domain are regarded as having substantially constant channel quality.

The frequency variation measurement part 112 outputs the calculated C_{BW} as frequency variation information S_{FDO} to the two-dimensional control part 113. Further, the two-dimensional control part 113 performs two-dimensional blocking, using the coherent time C_{T} input from the time variation measurement part 111 and the coherent bandwidth C_{BW} input from the frequency variation measurement part 112.

In this example, the time variation measurement part 111 calculates the coherent time C_{T} from a relational expression of C_{T}=1/(2F_{d}) with use of Doppler frequency F_{d} (F_{d} is a real number not smaller than 0). The frequency variation measurement part 112 calculates the coherent bandwidth C_{BW} from a relational expression of C_{BW}=1/(2πτ) with use of delay spread τ (where τ is a real number not smaller than 0).

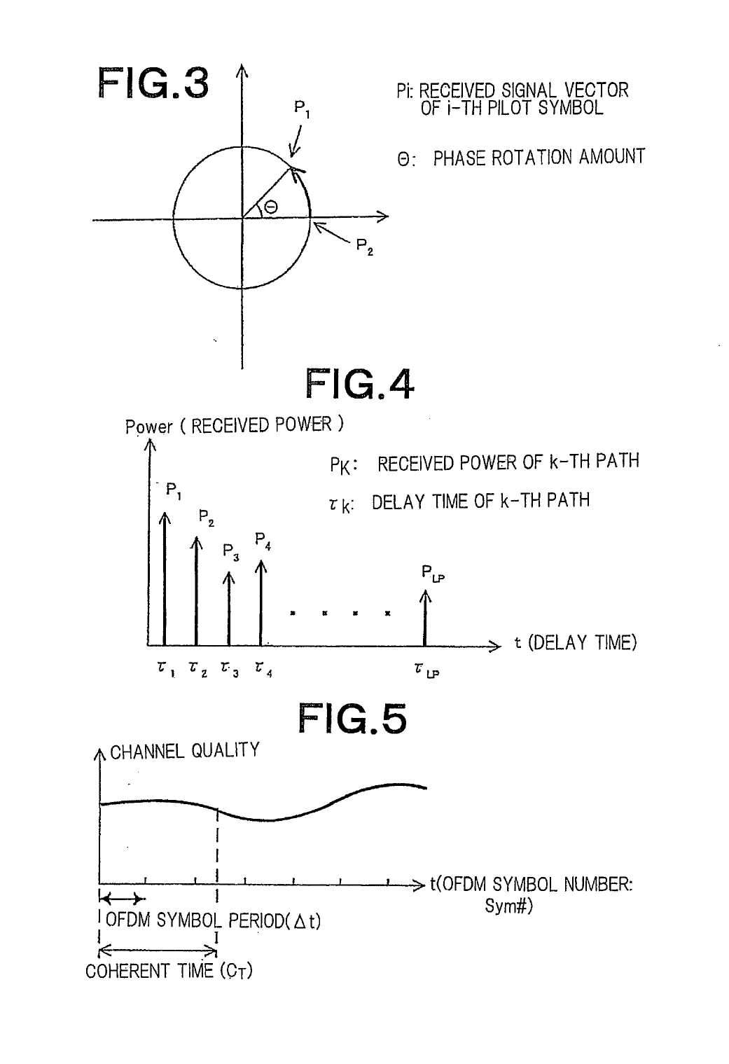

A method for estimating the Doppler frequency F_{d} used to calculate the coherent time C_{T} may be estimation using a phase rotation amount θ [rad] (where θ is a real number not smaller than 0) with respect to a known pilot symbol. An example will now be described supposing that, as shown in FIG. 3, P₁ and P₂ are received signal vectors respectively corresponding to first and second pilot symbols and that tp represents the interval between the P₁ and P₂ in a time domain. The phase rotation amount θ can be calculated from a relational expression of θ={cos⁻¹(P₁·P₁)}/tp (where · denotes an inner product). Using the calculated θ, the Doppler frequency F_{d} can be calculated from a relational expression of F_{d}=θ/{2πtp}.

Meanwhile, a method for estimating the delay spread τ used to calculate the coherent bandwidth C_{BW} may be estimation using a delay profile. An example will now be described supposing a case in which: L_{P} paths (where L_{P} is an integer not smaller than 1) are detected as shown in FIG. 4; delay time of each path is expressed as τₖ (where τₖ is a real number not smaller than 0 and k=1, 2, . . . , Lₚ); and received power of each path is expressed as Pₖ (where Pₖ is a real number greater than 0). In this case, the delay spread τ can be calculated from a relational expression as follow.

$$τ = \sqrt{{\sum }_{k = 1}^{Lp} {P}_{k} {τ}_{k}^{2} / P - {E}^{2}} \qquad [ Math 1 ]$$

In this expression, the followings are given.

$$\begin{matrix}E = {\sum }_{k = 1}^{Lp} {P}_{k} {τ}_{k} / P & [ Math 2 ] \\ P = {\sum }_{k = 1}^{Lp} {P}_{k} & [ Math 3 ]\end{matrix}$$

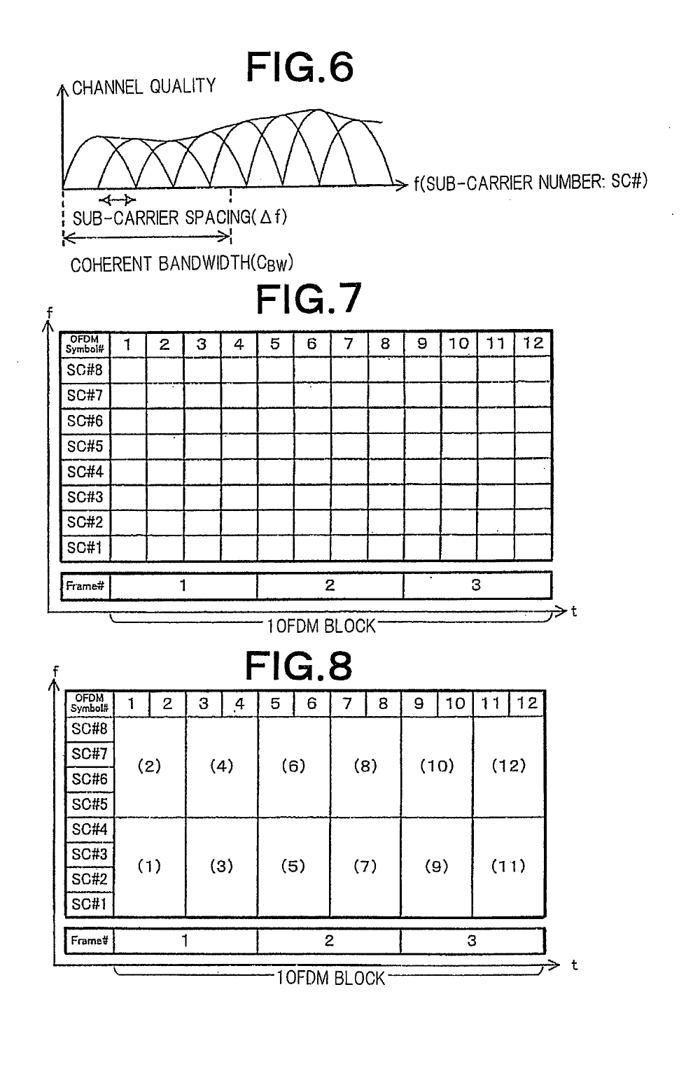

As shown in FIG. 5, the number of sub-carriers j_{c} (where j_{c} is an integer not smaller than 1) included in the coherent time C_{T} in the time domain is expressed as j_{c}≦C_{T}/Δₜ (where Δt is one OFDM symbol period which is a real number greater than 0). Meanwhile as shown in FIG. 6, the number of sub-carriers n_{c} (where n_{c} is an integer not smaller than 1) included in the coherent bandwidth C_{BW} in the frequency domain is expressed as n_{c}≦C_{BW}/Δf−1 (where Δf is a sub-carrier spacing which is a real number greater than 0).

In this example, the two-dimensional control part 113 arbitrarily sets the numbers j and n of sub-carriers per two-dimensional block respectively in the time domain and the frequency domain (where j and n are respectively divisors of J and N, and J=F×G is given), using the coherent time C_{T} and the coherent bandwidth C_{BW}. However, the total number L of two-dimensional blocks can be adaptively controlled.

Therefore, in this example, the numbers j and n of sub-carriers per two-dimensional block are arbitrarily set so as to fall within the coherent time C_{T} and the coherent bandwidth C_{BW} in the time domain and frequency domain, respectively.

Also in this example, the feedback frequency indicating the number of times by which feedback is performed per one OFDM block in the time domain, and the feedback information amount which is fed back at a time are adaptively controllable.

Also in this example, the feedback frequency and the feedback information amount at a time are determined based on two-dimensional blocking in an immediately previous OFDM block. The channel quality in each two-dimensional block and the sub-carrier numbers j and n per two-dimensional block which has been determined in the immediately previous OFDM block are feedback information.

If the feedback frequency and the feedback information amount at a time are set based on two-dimensional blocking in the immediately previous OFDM block, as in this example, there is considered a method for setting the feedback frequency and the feedback information amount at a time, based on preset values. There can be an alternative method in which a dummy is transmitted for the first OFDM block without performing feedback and feedback based on values determined in an immediately previous OFDM block is performed in the second and later OFDM blocks.

FIGS. 7 to 9 is to explain two-dimensional blocking performed by the two-dimensional control part 113 in this example. In this example, as shown in FIG. 7, one OFDM symbol consists of eight (N=8) sub-carriers, and one OFDM block consists of three frames (G=3) each consisting of four (F=4) OFDM symbols. One OFDM symbol period is 0.01 sec (Δt=0.01), and one sub-carrier spacing is 100 Hz (Δf=100).

In this example, there is supposed that measurement of propagation channel characteristics of the first OFDM block results in the Doppler frequency F_{d}=20 Hz and the delay spread τ=0.30 msec.

In this case, the time variation measurement part 111 calculates the coherent time C_{T} as time variation information, to obtain C_{T}=1/(2F_{d})=1/(2×20)=0.025 sec. Further, the frequency variation measurement part 112 calculates the coherent bandwidth C_{BW} as frequency variation information, to obtain C_{BW}=1/(2πτ)=1/(2π×0.30×10−3)=531 Hz. Based on these calculated coherent time C_{T} and coherent bandwidth C_{BW}, the two-dimensional control part 113 performs two-dimensional blocking.

In this example, the number j_{c} of sub-carriers included in the coherent time C_{T} is obtained as j_{c}=2 from j_{c}≦C_{T}/Δt=0.025/0.01=2.50. Meanwhile, the number n_{c} of sub-carriers included in the coherent bandwidth C_{BW} is obtained as n_{c}=4 from n_{c}≦(C_{BW}/Δf−1)=(531/100−1)=4.31.

Hence, the two-dimensional control part 113 sets the sub-carrier numbers j and n per two-dimensional block so as to fall within the coherent time C_{T} and the coherent bandwidth C_{BW} in the time domain and the frequency domain, respectively. For example, n is set to any of {1, 2, 4} which satisfy n≦n_{c}=4 from among {1, 2, 4, 8} which are divisors of 8 (=N). Further, j is set to any of {1, 2} which satisfy j≦j_{c}=2 from among {1, 2, 3, 4, 6, 12} which are divisors of 12 (=J).

Since the feedback information amount can be more suppressed as the values of n and j increase greater, n and j are respectively set to 4 and 2. In this case, the total number L (=K×M) is obtained as L=K×M=6×2=12 form K=J/j=12/2=6 and M=N/n=2.

In this example, the feedback frequency and the feedback information amount at a time are determined based on two-dimensional blocking in an immediately previous OFDM block. Therefore, once a second OFDM block is received, two-dimensional blocking is carried out as shown in FIG. 8 (see two-dimensional blocks (1) to (12)).

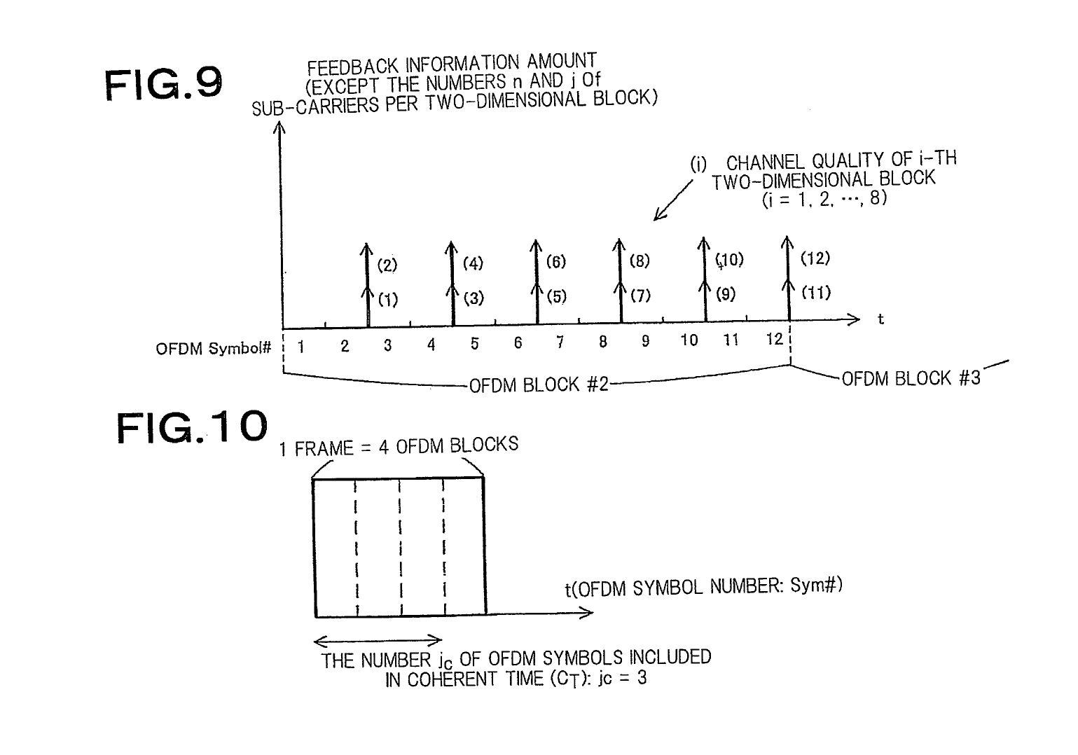

Further as shown in FIG. 9, the channel quality of two-dimensional blocks (1) to (12) and the numbers n=4 and j=2 of sub-carriers per two-dimensional block, which are determined in the first OFDM block, are fed back in order from the two-dimensional block assigned with the youngest number.

In this example, based on two-dimensional blocking determined for the first OFDM block, two-dimensional blocking of the second OFDM block is carried out. However, there can be another available method in which C_{T}, C_{BW}, j_{c}, and n_{c} are calculated for top Z frame or frames (where Z is a natural number, e.g., Z=1) of a Y-th OFDM block (where Y is a natural number, e.g., Y=1), and two-dimensional blocking of the Y-th OFDM block itself is performed based on calculated results.

### SECOND EXAMPLE

Next, the second example of the present invention will be described. However, the same descriptions as made above in the first example will be partially applied to the second example, concerning the structure of the OFDM communication system shown in FIG. 1 described previously, the method for measuring the Doppler frequency as shown in FIG. 3, the method for measuring the delay spread as shown in FIG. 4, indices in the time domain shown in FIG. 5 and used for two-dimensional blocking, and indices in the frequency domain used for two-dimensional blocking as shown in FIG. 6. Those same descriptions will be omitted here, and only differences will be described below.

In this example, variation of the channel quality are determined sequentially, and the OFDM block length, which is equivalent to the number of OFDM symbols included in one OFDM block is determined on the basis of the coherent time C_{T}.

Also in this example, the two-dimensional control part 113 arbitrarily sets the numbers j and n of sub-carrier per two-dimensional block respectively in the time domain and the frequency domain (where j and n are respectively divisors of J and N, and J=F×G is given), using the coherent time C_{T} and the coherent bandwidth C_{BW}. However, the total number L of two-dimensional blocks (where L=K×M, K=J/j, and M=N/n are given) can be adaptively controlled.

Based on the coherent time C_{T} and the coherent bandwidth C_{BW}, two-dimensional blocking is performed. Based on a result of the two-dimensional blocking, the feedback frequency and the feedback information amount at a time are adaptively set.

In this example, the coherent time C_{T} and the coherent bandwidth C_{BW} are calculated for one top frame of each OFDM block, and one OFDM block is determined so that the OFDM block length falls within the coherent time C_{T}. Therefore, in this example, if the coherent time C_{T} is equal to one frame or longer, the number j of sub-carriers per two-dimensional block in the time domain is equal to the number of OFDM symbols (=OFDM block length) in one OFDM block. Further, two-dimensional blocking is carried out in the OFDM block determined, and the feedback frequency and the feedback information amount at a time are set.

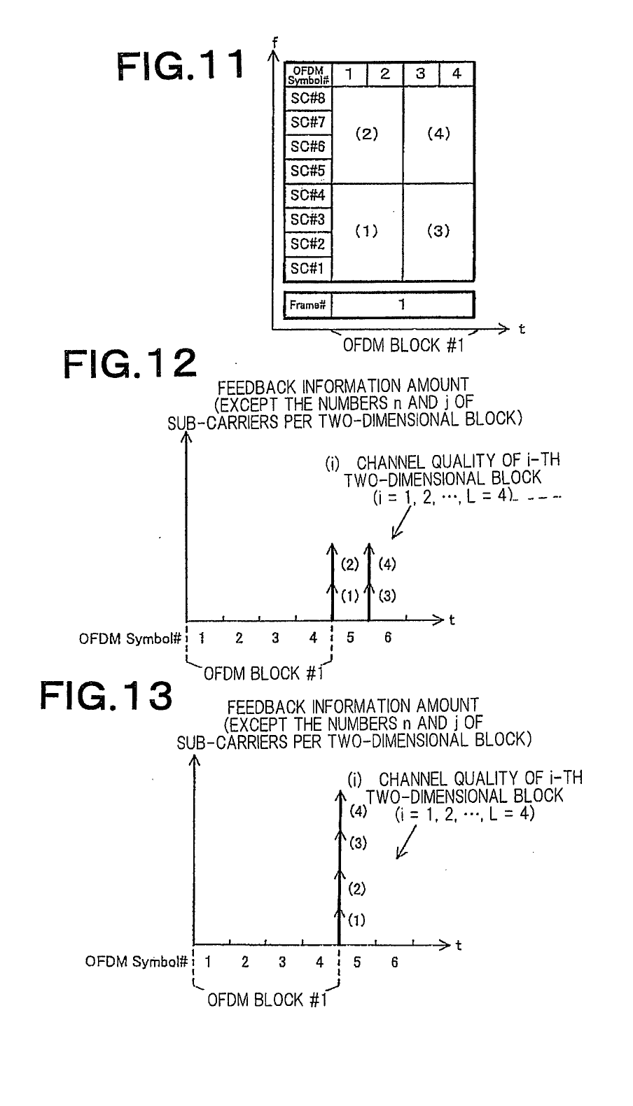

FIGS. 10 to 17 is to explain two-dimensional blocking performed by the two-dimensional control part 113 in this example. In this example, as shown in FIG. 11, one OFDM symbol consists of eight (N=8) sub-carriers, and one frame consists of four (F=4) OFDM symbols. One OFDM symbol period is 0.01 sec (Δt=0.01), and one sub-carrier spacing is 100 Hz (Δf=100).

In this example, there is supposed that measurement of propagation channel characteristics of the first frame results in the Doppler frequency F_{d}=15 Hz and the delay spread τ=0.25 msec.

In this case, the time variation measurement part 111 calculates the coherent time C_{T} as time variation information, to obtain C_{T}=1/(2F_{d})=1/(2×15)=0.033 sec. Therefore, the number j_{c1} of sub-carriers included in the coherent time C_{T} is obtained as j_{c1}=3 from j_{c1}≦C_{T}/Δt=0.033/0.01=3.30 (where the suffix 1 of j_{C1} represents the frame number), as shown in FIG. 10. In this example, the number of sub-carriers (=the number of OFDM symbols) in the time domain within one frame is 4, which exceeds the number j_{c1} of sub-carriers (=3) included in the coherent time C_{T} (or cannot fall within the coherent time C_{T}). Therefore, as shown in FIG. 11, two-dimensional blocking is carried out, taking only the first frame as the first OFDM block.

Further, the frequency variation measurement part 112 calculates the coherent bandwidth C_{BW} as frequency variation information, to obtain C_{BW}=1/(2πτ)=1/(2π×0.25×10−3)=637 Hz. In this case, the number n_{c1} of sub-carriers included in the coherent bandwidth C_{BW} is obtained as n_{c1}=5 from n_{c1}≦(C_{BW}/Δf−1)=(637/100−1)=5.37.

In this example, the two-dimensional control part 113 can arbitrarily set the numbers j and n of sub-carriers per two-dimensional block so as to fall within the coherent time C_{T} and the coherent bandwidth C_{BW} in the time domain and the frequency domain, respectively. For example, n is set to any of {1, 2, 4} which satisfy n≦n_{c1=5} from among {1, 2, 4, 8} which are divisors of 8 (=N). Further, j is set to any of {1, 2} which satisfy j≦j_{c1}=3 from among {1, 2, 4} which are divisors of 4 as the number of OFDM symbols included in one frame.

Since the feedback information amount can be more suppressed as the values of n and j increase greater, two-dimensional blocking is carried out, with n and j respectively set to 4 and 2 in the first OFDM block by the two-dimensional control part 113, as shown in FIG. 11 (two-dimensional blocks (1) to (4) in the figure).

In this example, the feedback frequency and the feedback information amount at a time can be adaptively set. Therefore, as shown in FIG. 12, the channel quality of the two-dimensional blocks (1) to (4), and the numbers n=4 and j=2 of sub-carriers per two-dimensional block, which are determined in the first OFDM block, are fed back in order from the two-dimensional block assigned with the youngest number. At this time, feedback can be performed as shown in FIG. 13 so as to be able to follow variation of the channel quality in the time domain.

Next, there is supposed that measurement of propagation channel characteristics in the second frame which is the top of the second OFDM block results in the Doppler frequency F_{d}=5 Hz and the delay spread τ=0.32 msec.

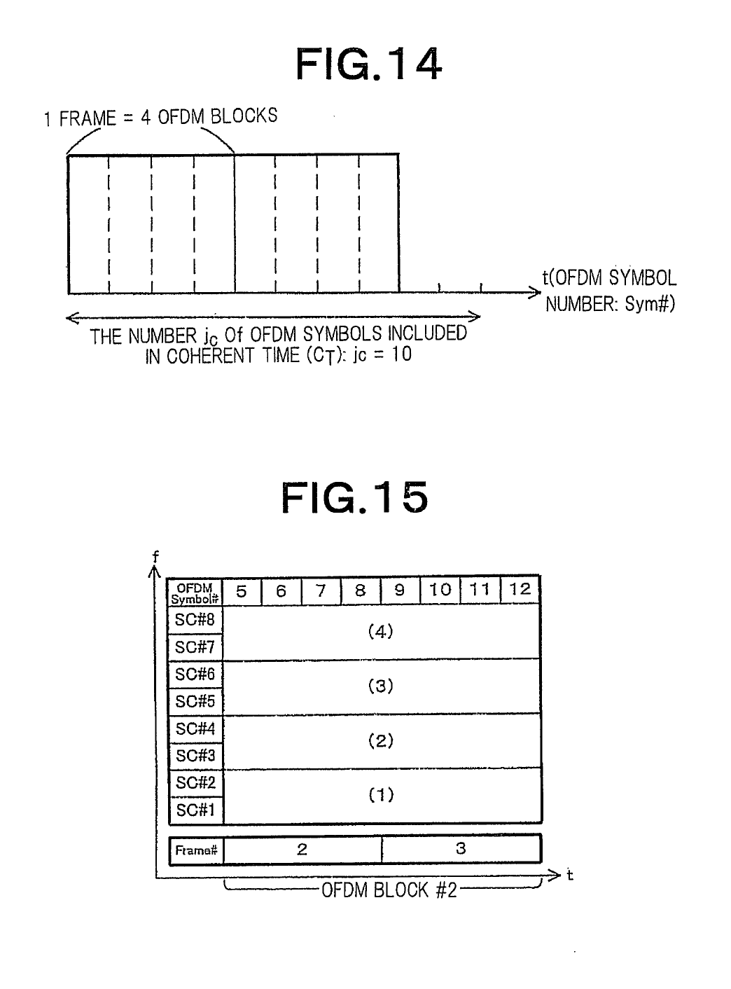

In this case, the time variation measurement part 111 calculates the coherent time C_{T} as time variation information, to obtain C_{T}=1/(2F_{d})=1/(2×5)=0.100 sec. Therefore, the number j_{c2} Of sub-carriers included in the coherent time C_{T} is obtained as j_{c2}=10 from j_{c2}≦C_{T}/Δt=0.0100/0.01=10.0, as shown in FIG. 14. In this example, the number of sub-carriers (=the number of OFDM symbols) in the time domain within one frame is 4, which is smaller than the number j_{c2} of sub-carriers (=10) included in the coherent time C_{T} (or can fall within the coherent time C_{T}). In this case, one OFDM block is determined so that the OFDM block length is smaller than j_{c2} (=10) and is an integral multiple of the frame consisting of four OFDM symbols. Therefore, the length of the second OFDM block is set to eight.

Further, the frequency variation measurement part 112 calculates the coherent bandwidth C_{BW} as frequency variation information, to obtain C_{BW}=1/(2πτ)=1/(2π×0.32×10−3)=498 Hz. In this case, the number n_{c2} of sub-carriers included in the coherent bandwidth C_{BW} is obtained as n_{c2}=3 from n_{c2}≦(C_{BW}/Δf−1)=(498/100−1)=3.98.

In this example, the two-dimensional control part 113 can set n to any of {1, 2} which satisfy n≦n_{C2}=3 from among {1, 2, 4, 8} which are divisors of 8 (=N). Hence, n=2 is set in order to suppress the feedback information amount as much as possible. On the other side, since the length of the second OFDM block has already been set to j_{c2} (=10) so as to fall within the coherent time C_{T}, j is set to eight as the OFDM block length. Accordingly, the second OFDM block is as shown in FIG. 15 (see two-dimensional blocks (1) to (4) in the figure).

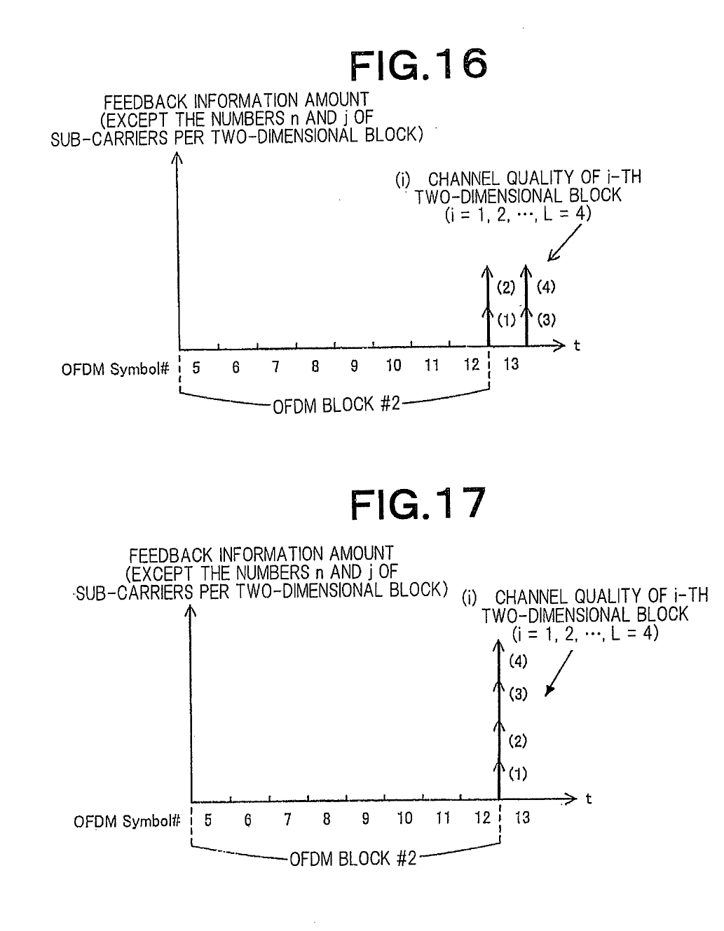

Further, as shown in FIG. 16, the channel quality of the two-dimensional blocks (1) to (4), and the numbers n=2 and j=8 of sub-carriers per two-dimensional block, which are determined in the second OFDM block, are fed back in order from the two-dimensional block assigned with the youngest number. At this time, feedback can be performed as shown in FIG. 17 so as to be able to follow variation of the channel quality in the time domain. In this case, j can be arbitrarily set from among {1, 2, 4, 8} which are divisors of 8.

Determination of the length of the third OFDM block is made in the fourth frame which is the top of the third OFDM block.

### THIRD EXAMPLE

Next, the third example of the present invention will be described. Note that, the same descriptions as made above in the first example will be partially applied to the third example, concerning the structure of the OFDM communication system shown in FIG. 1, the method for measuring the Doppler frequency as shown in FIG. 3, the method for measuring the delay spread as shown in FIG. 4, indices in the time domain used for two-dimensional blocking as shown in FIG. 5, and indices in the frequency domain used for two-dimensional blocking as shown in FIG. 6. The same descriptions will be omitted here, and only differences will be described below.

In this example, the two-dimensional control part 113 arbitrarily sets the numbers j and n of sub-carriers per two-dimensional block respectively in the time domain and the frequency domain (where j and n are arbitrary divisors of J and N which are multiplied by each other to give a constant product, and J=F×G is given), using the coherent time C_{T} and the coherent bandwidth C_{BW} so as to make a total number L of two-dimensional blocks in one OFDM block constant. In this case, the number P of sub-carriers per two-dimensional block is P=N×J/L (=j×n).

In this example, n_{c}/j_{c} is calculated as a correlation between the number of sub-carriers j_{c} included in the coherent time C_{T} and the number of sub-carriers n_{c} included in the coherent bandwidth C_{BW}. Among values which n/j can take depending on the number of sub-carriers P per two-dimensional block, one value which is closest to the value of calculated n_{c}/J_{c} is selected. Based on the selected value, n and j are set.

Channel quality of each two-dimensional block based on two-dimensional blocking performed in an immediately previous OFDM block, and the numbers n and j of sub-carriers per two-dimensional block, which are determined in the immediately previous OFDM block, are feedback information.

In this example, the feedback frequency indicating the number of times by which feedback is performed per one OFDM block in the time domain, and the feedback information amount which is fed back at a time are both adaptively controllable.

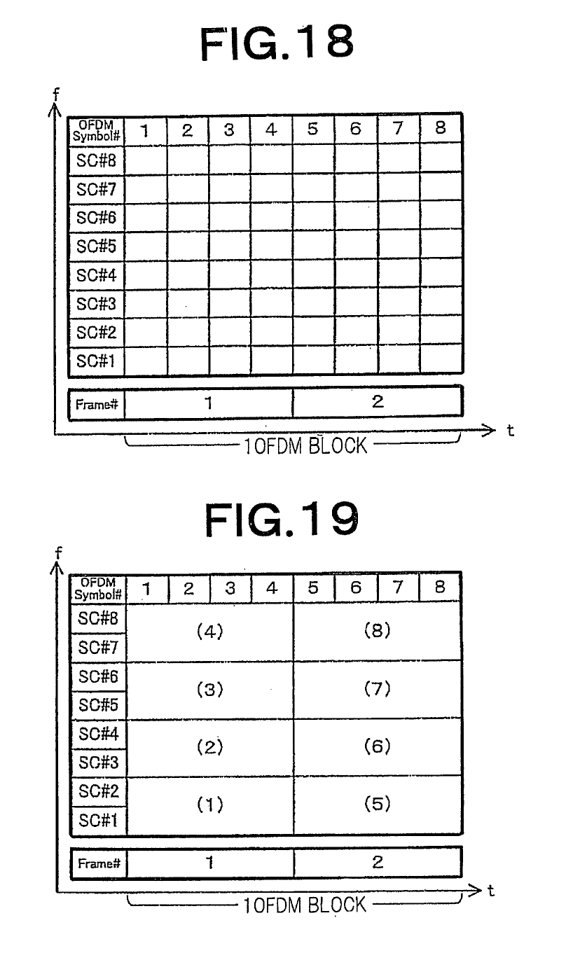

FIGS. 18 to 20 is to explain two-dimensional blocking performed by the two-dimensional control part 113 in this example. In this example, as shown in FIG. 18, one OFDM symbol consists of eight (N=8) sub-carriers, and one OFDM block consists of two frames (G=2) each consisting of four (F=4) OFDM symbols. One OFDM symbol period is 0.01 sec (Δt=0.01), and one sub-carrier spacing is 100 Hz (Δf=100). Further, the total number L of two-dimensional blocks is maintained at a constant value, i.e., eight. Accordingly, the number P of sub-carriers per two-dimensional block is P=N×J/L=8×8/8=8.

In this example, there is supposed that measurement of propagation channel characteristics of the first OFDM block results in the Doppler frequency F_{d}=10 Hz and the delay spread τ=0.50 msec.

In this case, the time variation measurement part 111 calculates the coherent time C_{T} as time variation information, to obtain C_{T}=1/(2F_{d})=1/(2×10)=0.050 sec. Further, the frequency variation measurement part 112 calculates the coherent bandwidth C_{BW} as frequency variation information, to obtain C_{BW}=1/(2πτ)=1/(2τ×0.50×10−3)=318 Hz.

In this example, the number j_{c} of sub-carriers included in the coherent time C_{T} is obtained as j_{c}=5 from j_{c}≦C_{T}/Δt=0.050/0.010=5.00. Meanwhile, the number of sub-carriers n_{c} included in the coherent bandwidth C_{BW} is obtained as n_{c}=2 from n_{c}≦(C_{BW}/Δf−1)=(318/100−1)=2.18. In this case, the value of n_{c}/j_{c} is obtained as n_{c}/j_{c}=2/5. Four values of {1/8, 2/4, 4/2, 8/1} can be taken by n/j which satisfy P=n×j=8. Among the four values, 2/4 is closest to n_{c}/j_{c}=2/5. Accordingly, n and j are respectively set to 2 and 4, and two-dimensional blocking is carried out as shown in FIG. 19 (see two-dimensional blocks (1) to (8) in the figure).

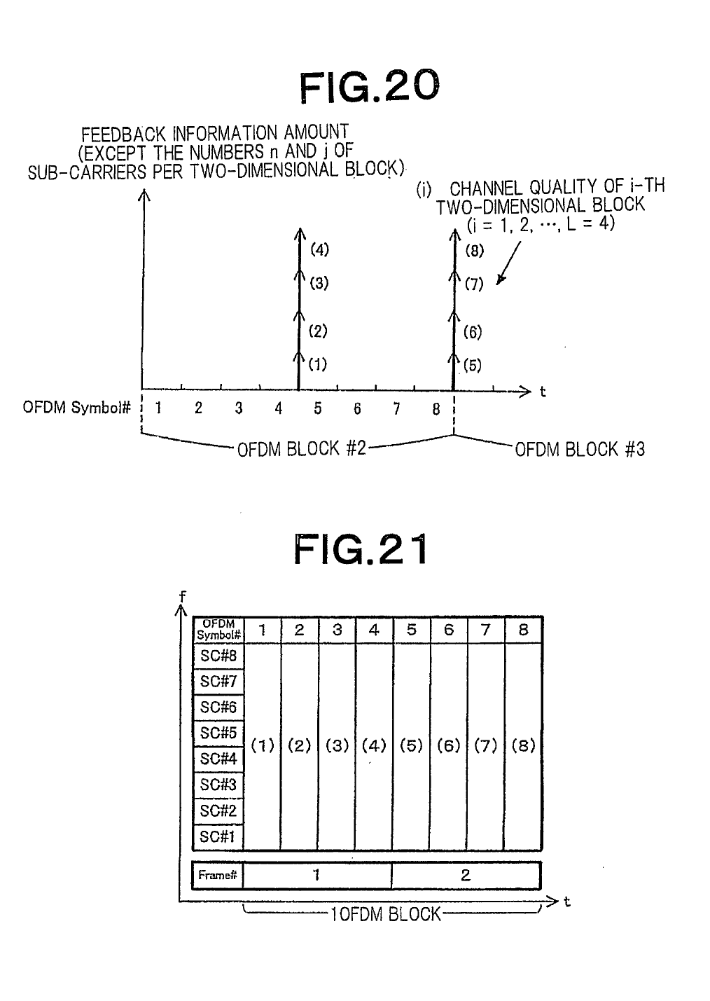

In this example, the feedback frequency and the feedback information amount at a time can be adaptively set. Therefore, in the second OFDM block length as shown in FIG. 20, the channel quality of the two-dimensional blocks (1) to (8), and the numbers n=2 and j=4 of sub-carriers per two-dimensional block, which are determined in the first OFDM block, are fed back in order from the two-dimensional block assigned with the youngest number.

### FOURTH EXAMPLE

Next, the fourth example of the present invention will be described. Note that, the same descriptions as made above in the first example will be partially applied to the fourth example, concerning the structure of the OFDM communication system shown in FIG. 1, the method for measuring the Doppler frequency as shown in FIG. 3, the method for measuring the delay spread as shown in FIG. 4, indices in the time domain used for two-dimensional blocking as shown in FIG. 5, and indices in the frequency domain used for two-dimensional blocking as shown in FIG. 6. The same descriptions will be omitted here, and only differences will be described below.

In this example, the two-dimensional control part 113 arbitrarily sets the numbers j and n of sub-carriers per two-dimensional block respectively in the time domain and the frequency domain (where j and n are respectively arbitrary divisors of J and N which are multiplied by each other to give a constant product, and J=F×G is given), using the coherent time C_{T} and the coherent bandwidth C_{BW} so as to make a total number L of two-dimensional blocks in one OFDM block constant. In this case, the number P of sub-carriers per two-dimensional block is P=N×J/L (=j×n).

In this example, n_{c}/j_{c} is calculated as correlation between the number of sub-carriers j_{c} included in the coherent time C_{T} and the number of sub-carriers n_{c} included in the coherent bandwidth C_{BW}. Among values which n/j can take depending on the number of sub-carriers P per two-dimensional block, one value which is closest to the value of calculated n_{c}/j_{c} is selected. Based on the selected value, n and j are set.

Channel quality of each two-dimensional block and the numbers n and j of sub-carriers per two-dimensional block, which are determined in the immediately previous OFDM block, are feedback information.

Further, in this example, the feedback frequency indicating the number of times by which feedback is performed per one OFDM block in the time domain, and the feedback information amount which is fed back at a time are respectively maintained constant.

FIGS. 21 to 24 are to explain two-dimensional blocking performed by the two-dimensional control part 113 in this example. In this example, as shown in FIG. 21, one OFDM symbol consists of eight (N=8) sub-carriers, and one OFDM block consists of two frames (G=2) each consisting of four (F=4) OFDM symbols. One OFDM symbol period is 0.01 sec (Δt=0.01), and one sub-carrier spacing is 100 Hz (Δf=100). Further, the total number L of two-dimensional blocks is maintained at a constant value, i.e., eight. Accordingly, the number P of sub-carriers per two-dimensional block is P=N×J/L=8×8/8=8.

In this example, the total number L of two-dimensional blocks is eight in this example. Therefore, the feedback frequency is set to four times and the feedback information amount at a time is set to be equivalent to two two-dimensional blocks, so that the feedback frequency, and the number of values indicating channel quality and included in feedback information which is fed back at a time, for each two-dimensional block, are multiplied by each other to give eight (=L) as a product. Each of the feedback frequency and the feedback information amount at a time is maintained constant.

In this example, there is supposed that measurement of propagation channel characteristics of the first OFDM block results in the Doppler frequency F_{d}=40 Hz and the delay spread τ=0.15 msec.

In this case, the time variation measurement part 111 calculates the coherent time C_{T} as time variation information, and the obtained coherent time is C_{T}=1/(2F_{d})=1/(2×40)=0.0125 sec. Further, the frequency variation measurement part 112 calculates the coherent bandwidth C_{BW} as frequency variation information, and the obtained coherent time is C_{BW}=1/(2πτ)=1/(2π×0.15×10−3)=1062 Hz.

In this example, the number of sub-carriers j_{c} included in the coherent time C_{T} is obtained as j_{c}=1 from j_{c}≦C_{T}/Δt=0.0125/0.010=1.25. Meanwhile, the number of sub-carriers n_{c} included in the coherent bandwidth C_{BW} is obtained as n_{c}=9 from n_{c}≦(C_{BW}/Δf−1)=(1062/100−1)=9.62. In this case, the value of n_{c}/j_{c} is obtained as n_{c}/j_{c}=9/1. Four values of {1/8, 2/4, 4/2, 8/1} can be taken by n/j which satisfy P=n×j=8. Among the four values, 8/1 is closest to n_{c}/j_{c}=9/1. Accordingly, n and j are respectively set to 8 and 1, and two-dimensional blocking is carried out as shown in FIG. 21 (see two-dimensional blocks (1) to (8) in the figure).

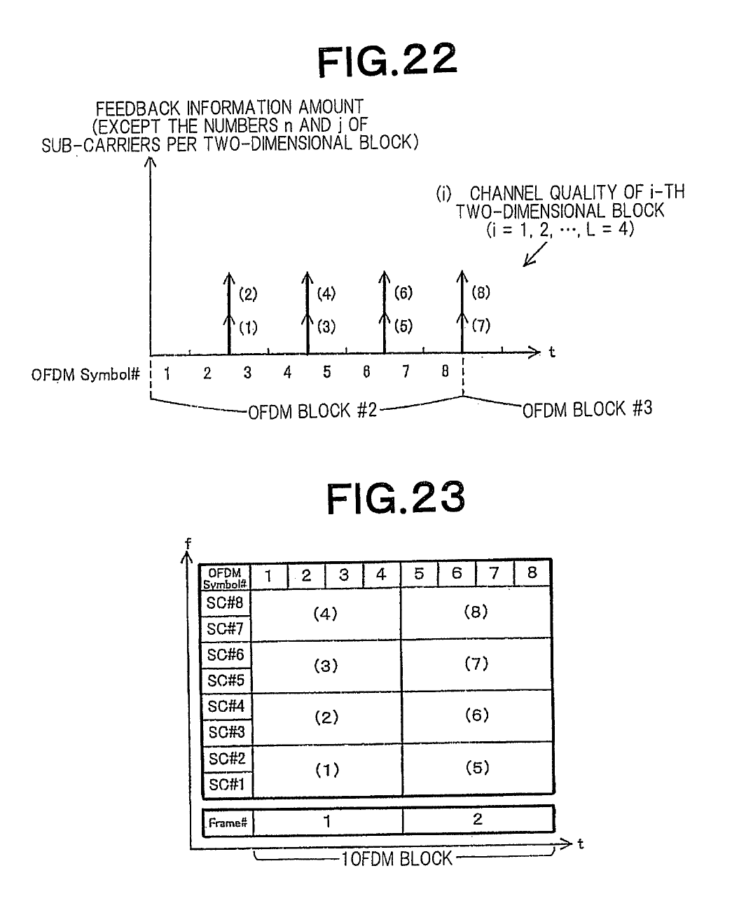

In this example, the feedback frequency is set to four times, and the feedback information amount at a time is set to be equivalent to two two-dimensional blocks. Therefore, in the second OFDM block as shown in FIG. 22, the numbers n=8 and j=1 of sub-carriers per two-dimensional block, which are determined in the first OFDM block, and every two of values indicating channel quality of the two-dimensional blocks (1) to (8) in order from the two-dimensional block assigned with the youngest number are fed back once for every two OFDM symbols.

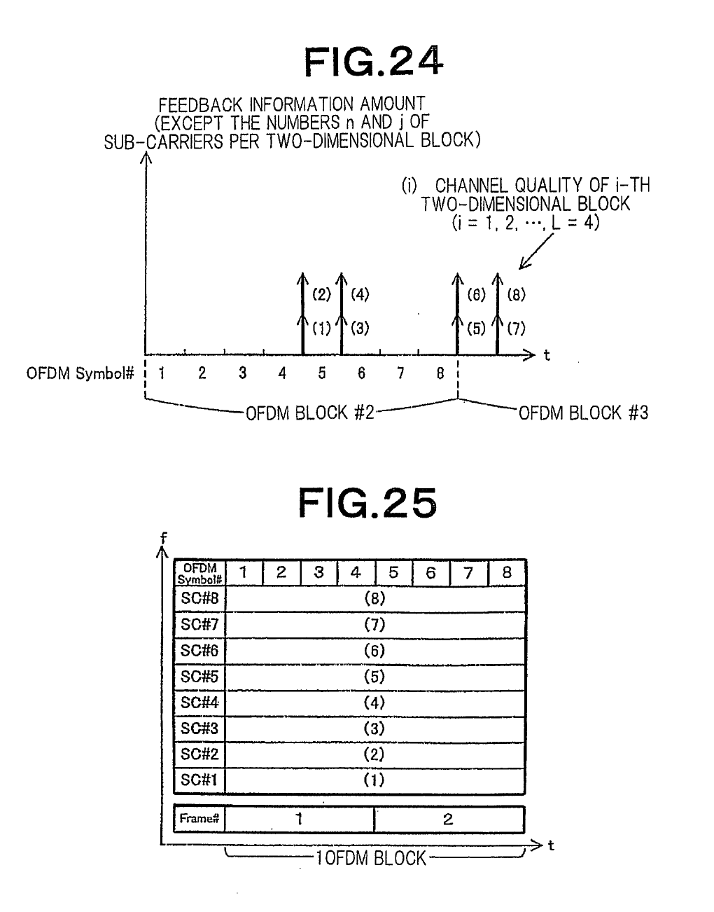

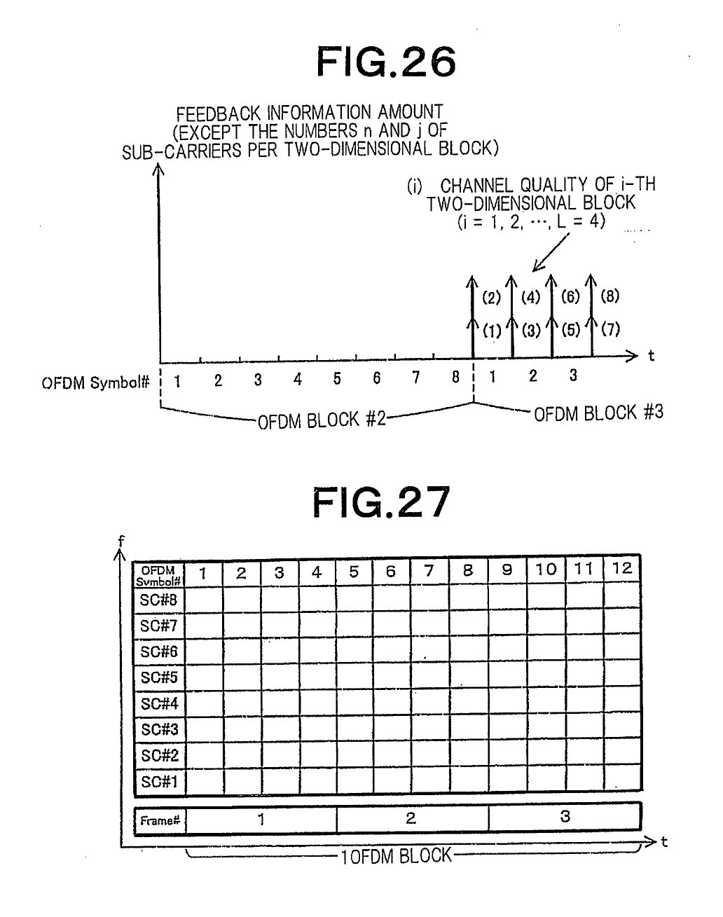

Also, in this example, if two-dimensional blocking is carried out as shown in FIGS. 23 and 25 (see two-dimensional blocks (1) to (8) in the figures), feedback is performed as shown in FIGS. 24 and 26, respectively.

### FIFTH EXAMPLE

Next, the fifth example of the present invention will be described. However, the same descriptions as made above in the first example will be partially applied to the fifth example, concerning the method for measuring the Doppler frequency as shown in FIG. 3, the method for measuring the delay spread as shown in FIG. 4, indices in the time domain used for two-dimensional blocking as shown in FIG. 5, and indices in the frequency domain used for two-dimensional blocking as shown in FIG. 6. The same descriptions will be omitted here, and only differences will be described below.

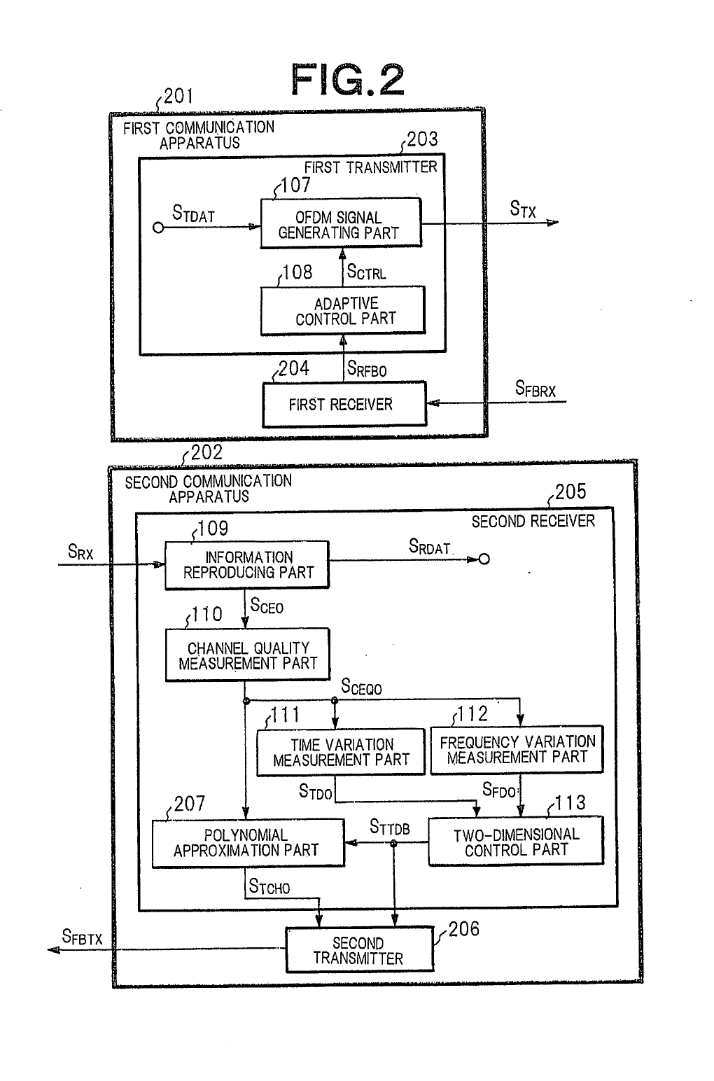

FIG. 2 is a block diagram showing a structure of an OFDM communication system according to this example. In this example, one frame consists of F OFDM symbols (where F is an integer not smaller than 1) each consisting of N sub-carriers (where N is an integer not smaller than 2). Also in this example, two-dimensional blocks are numbered consecutively in order from the two-dimensional block to which an OFDM symbol assigned with the youngest number and a sub-carrier assigned with the youngest number belong in each OFDM block consisting of G frames (where G is an integer not smaller than 1).

In FIG. 2, the OFDM communication system according to this example includes a first communication apparatus 201 having a first transmitter 203 and a first receiver 204, and a second communication apparatus 202 having a second receiver 205 and a second transmitter 206. The first communication apparatus 201 and the second communication apparatus 202 are constituted by, for example, a base station and a mobile station.

In the first communication apparatus 201, the first transmitter 203 has an OFDM signal generating part 107 and an adaptive control part 108.

The adaptive control part 108 is input with reproduced feedback information S_{RFBO} from the first receiver 204, and outputs control information S_{CTRL} to the OFDM signal generating part 107, based on the reproduced feedback information S_{RFBO}.

The OFDM signal generating part 107 is input with information data S_{TDAT} and the control information S_{CTRL} from the adaptive control part 108. Based on the data S_{TDAT} and information S_{CTRL}, the OFDM signal generating part 107 performs sub-carrier grouping in a manner that every nt adjacent sub-carriers (where nt is a divisor of N determined by the reproduced feedback information S_{RFBO}) are grouped, in order from the first sub-carrier among N sub-carriers, into a sub-carrier group assigned to a sub-carrier group number m (where m=1, 2, . . . , M, and M=N/n). Further, the OFDM signal generating part 107 performs link adaptation to set transmission parameters for each sub-carrier group, and generates and transmits a transmitted OFDM signal S_{TX} to the second communication apparatus 202.

In the second communication apparatus 202, the second receiver 105 has an information reproducing part 109, a channel quality measurement part 110, a time variation measurement part 111, a frequency variation measurement part 112, a two-dimensional control part 113, and a polynomial approximation part 207.

The information reproducing part 109 is input with a received OFDM signal S_{RX} corresponding to a transmitted OFDM signal S_{TX} from the first communication apparatus 201. Based on the received OFDM signal, the information reproducing part 109 outputs reproduction information data S_{RDAT} corresponding to information data S_{TDAT} and also outputs channel information S_{CEO} to the channel quality measurement part 110.

The channel quality measurement part 110 is input with the channel information S_{CEO} from the information reproducing part 109. Based on this information, the channel quality measurement part 110 measures channel quality for each sub-carrier, and outputs measured results, as channel quality information S_{CEQO}, to each of the time variation measurement part 111, frequency variation measurement part 112, and polynomial approximation part 207.

The time variation measurement part 111 is input with the channel quality information S_{CEQO} from the channel quality measurement part 110. Based on this information, the time variation measurement part 111 measures variation of the channel quality in a time domain, and outputs a measured result, as time variation information S_{TDO}, to the two-dimensional control part 113.

The frequency variation measurement part 112 is input with the channel quality information S_{CEQO} from the channel quality measurement part 110. Based on this information, the frequency variation measurement part 112 measures variation of the channel quality in a frequency domain, and outputs a measured result, as frequency variation information S_{FDO}, to the two-dimensional control part 113.

The two-dimensional control part 113 is input with the time variation information S_{TDO} and the frequency variation information S_{FDO} respectively from the time variation measurement part 111 and the frequency variation measurement part 112. Based on these pieces of information, the two-dimensional control part 113 performs two-dimensional blocking so that one OFDM block consisting of G frames (where G is an integer not smaller than 1) is divided into two-dimensional blocks each consisting of plural sub-carriers which are adjacent to each other in each of the time domain and the frequency domain. The two-dimensional control part 113 outputs the number of sub-carriers per two-dimensional block in each of the time domain and the frequency domain, as two-dimensional control information S_{TTDB} to the polynomial approximation part 207.

The polynomial approximation part 207 is input with the channel quality information S_{CEQO} from the channel quality measurement part 110 and the two-dimensional control information S_{TTDB} from the two-dimensional control part 113. Based on these pieces of information, the polynomial approximation part 207 approximates variation of the channel quality to a polynomial, and outputs coefficients of the polynomial, inflection points thereof, and channel quality at the inflection points, or only the coefficients of the polynomial, as feedback quality information S_{TCHO} to the second transmitter 206.

The second transmitter 206 is input with the feedback quality information S_{TCHO} from the polynomial approximation part 207 and the two-dimensional control information S_{TTDB} from the two-dimensional control part 113. Based on these pieces of information, the second transmitter 206 generates and transmits a transmitted feedback signal S_{FBTX} to the first communication apparatus 201.

In the first communication apparatus 201, the first receiver 204 is input with a received feedback signal S_{FBRX} corresponding to the transmitted feedback signal S_{FBTX} from the second communication apparatus 202. Based on this signal, the first receiver 204 outputs reproduced feedback information S_{RFBO} corresponding to feedback information, to the adaptive control part 108.

By the operation as described above, channel information is fed back from the second communication apparatus 202 to the first communication apparatus 201, in accordance with channel states therebetween.

The polynomial approximation part 207 averages channel quality over all sub-carriers in each of two-dimensional blocks, and approximates variation of the channel quality between plural adjacent two-dimensional blocks in the time domain or frequency domain, to a polynomial.

In this example, the time variation measurement part 111 calculates a coherent time C_{T} (where C_{T} is a real number not smaller than 0) in which adjacent sub-carriers in the time domain are regarded as having substantially almost same channel quality, and outputs the calculated C_{T} as time variation information S_{TDO}. The frequency variation measurement part 112 calculates a coherent bandwidth C_{BW} (where C_{BW} is a real number not smaller than 0) in which adjacent sub-carriers in the frequency domain are regarded as having substantially almost same channel quality, and outputs the calculated C_{BW} as frequency variation information S_{FDO}. Further, the two-dimensional control part 113 performs two-dimensional blocking, by setting numbers j and n of sub-carriers per two-dimensional block respectively in the time domain and the frequency domain (where j and n are respectively arbitrary divisors of J and N which are multiplied by each other to give a constant product, and J=F×G is given), using the coherent time C_{T} and the coherent bandwidth C_{BW}, so that the total number L of two-dimensional blocks in one OFDM block is constant. In this case, the number P of sub-carriers per two-dimensional block is P=N×J/L (=j×n).

The polynomial approximation part 207 approximates variation of the channel quality throughout every M (=N/n) adjacent two-dimensional blocks in the frequency domain to one polynomial. In this example, a least squares method is used for the approximation, and the maximum order of the polynomial to be approximated to is set to 3. In this case, the number of polynomials in one OFDM block is J/j, and the polynomials are numbered in order from the polynomial to which the youngest-numbered two-dimensional block belongs. The polynomials are expressed as follows:

Y=C₀x³+C₁x²+C₂x+C₃

(where x=0, 1, 2, . . . , M−1 is given, y is a real number representing channel quality, and C₀, C₁, C₂, and C₃ are real numbers and coefficients of the polynomial)

In this example, the coherent time C_{T} is calculated from a relational expression of C_{T}=1/(2F_{d}) with use of Doppler frequency F_{d} (F_{d} is a real number not smaller than 0). The coherent bandwidth C_{BW} is calculated from a relational expression of C_{BW}=1/(2πτ) with use of delay spread τ (where τ is a real number not smaller than 0).

In this example, the number j_{c} (where j_{c} is an integer not smaller than 1) of sub-carriers included in the coherent time C_{T} in the time domain is obtained as j≦C_{T}/Δt (where Δt is one OFDM symbol period which is a real number greater than 0), as shown in FIG. 5 described previously. Meanwhile, the number n_{c} (where n_{c} is an integer not smaller than 1) of sub-carriers included in the coherent bandwidth C_{BW} in the frequency domain is obtained as n_{c}≦(C_{BW}/Δf−1) (where Δf is a sub-carrier spacing which is a real number greater than 0), as shown in FIG. 6 described previously.

In this example, n_{c}/j_{c} is calculated as a correlation between the number j_{c} of sub-carriers included in the coherent time C_{T} in the time domain and the number n_{c} of sub-carriers included in the coherent bandwidth C_{BW} in the frequency domain. Among values which n/j can take depending on the number P of sub-carriers per two-dimensional block, one value which is closest to the value of calculated n_{c}/j_{c} is selected. Based on the selected value, n and j are set.

In this example, the coefficients (C₀, C₁, C₂, and C₃) of the polynomial approximated to based on two-dimensional blocking in an immediately previous OFDM block, and the numbers n and j of sub-carriers per two-dimensional block which are determined also in the immediately previous OFDM block are feedback information. Further, the feedback frequency indicating the number of times by which feedback is performed per one OFDM block in the time domain, and the feedback information amount which is fed back at a time are adaptively controllable.

FIGS. 27 to 29 are to explain two-dimensional blocking performed by the two-dimensional control part 113 in this example. In this example, as shown in FIG. 27, one OFDM symbol consists of eight (N=8) sub-carriers, and one OFDM block consists of three frames (G=3) each consisting of four (F=4) OFDM symbols. One OFDM symbol period is 0.01 sec (Δt=0.01), and one sub-carrier spacing is 100 Hz (Δf=100). Further, the total number L of two-dimensional blocks is maintained at a constant value, e.g., eight. Accordingly, the number P of sub-carriers per two-dimensional block is P=N×J/L=8×12/8=12. An absolute value of a transfer path estimation value is used as channel quality.

In this example, there is supposed that measurement of propagation channel characteristics of the first OFDM block results in the Doppler frequency F_{d}=6 Hz and the delay spread τ=0.4 msec.

In this case, the time variation measurement part 111 calculates the coherent time C_{T} as time variation information to obtain C_{T}=1/(2F_{d})=1/(2×6)=0.083 sec. Further, the frequency variation measurement part 112 calculates the coherent bandwidth C_{BW} as frequency variation information to obtain C_{BW}=1/(2πτ)=1/(2π×0.4×10−3)=398 Hz.

In this example, the number j_{c} of sub-carriers included in the coherent time C_{T} is obtained as j_{c}=8 from j_{c}≦C_{T}/Δt=0.083/0.010=8.30. Meanwhile, the number n_{c} of sub-carriers included in the coherent bandwidth C_{BW} is obtained as n_{c}=2 from n_{c}≦(C_{BW}/Δf−1)=(398/100−1)=2.98. In this case, the value of n_{c}/j_{c} is obtained as n_{c}/j_{c}=2/8. Six values of {1/12, 2/6, 3/4, 4/3, 6/2, 12/1} can be taken by n/j which satisfy P=n×j=8. Among the four values, 2/6 is closest to n_{c}/j_{c}=2/8. Accordingly, n and j are respectively set to 2 and 6.

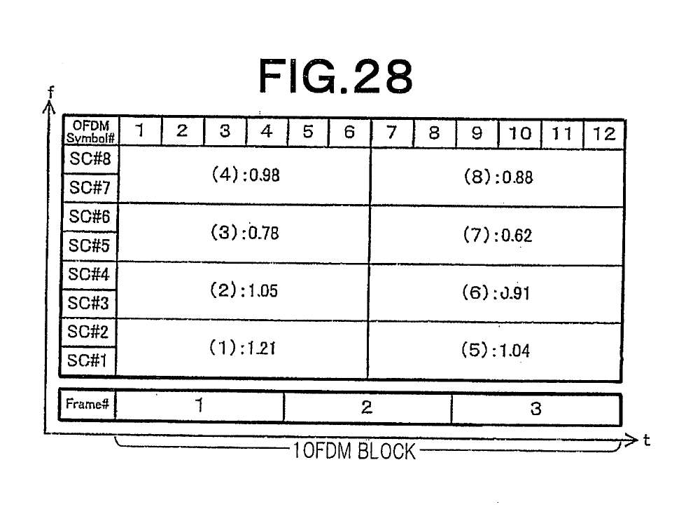

Hence, based on two-dimensional blocking determined in the first OFDM block, the second OFDM block is subjected to two-dimensional blocking as shown in FIG. 28 (see two-dimensional blocks (1) to (8) in the figure). In this example, variation of the channel quality throughout every four two-dimensional blocks which are adjacent to each other in the frequency domain is approximated to one polynomial. Therefore, the number of polynomials is J/j=12/6=2. Now, values indicating channel quality averaged respectively in two-dimensional blocks in the second OFDM block are shown in two-dimensional blocks (1) to (8) in FIG. 28.

In this case, a least squares method is used to approximate variation of the channel quality throughout four two-dimensional blocks (1) to (4) shown in FIG. 28, to a polynomial having the maximum order of three, as follows.

y=0.0967x³−0.3450x²+0.0883x+1.2100 Polynomial 1

(where x=0, 1, 2, 3)

Similarly, a least squares method is used to approximate variation of the channel quality throughout four two-dimensional blocks (5) to (8) shown in FIG. 28, to a polynomial having the maximum order of three, as follows.

y=0.1183x³−0.4350x²+0.1867x+1.0400 Polynomial 2

(where x=0, 1, 2, 3)

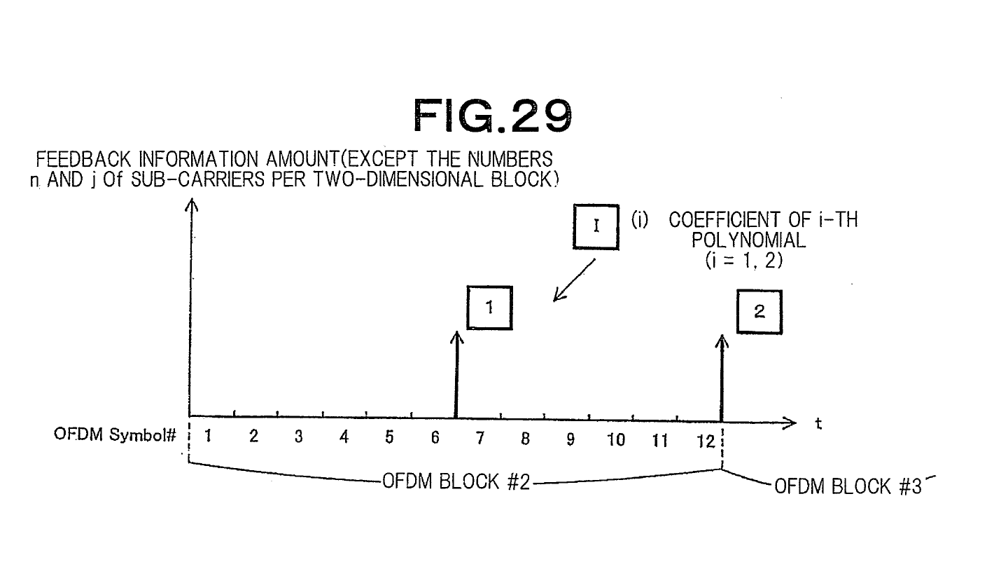

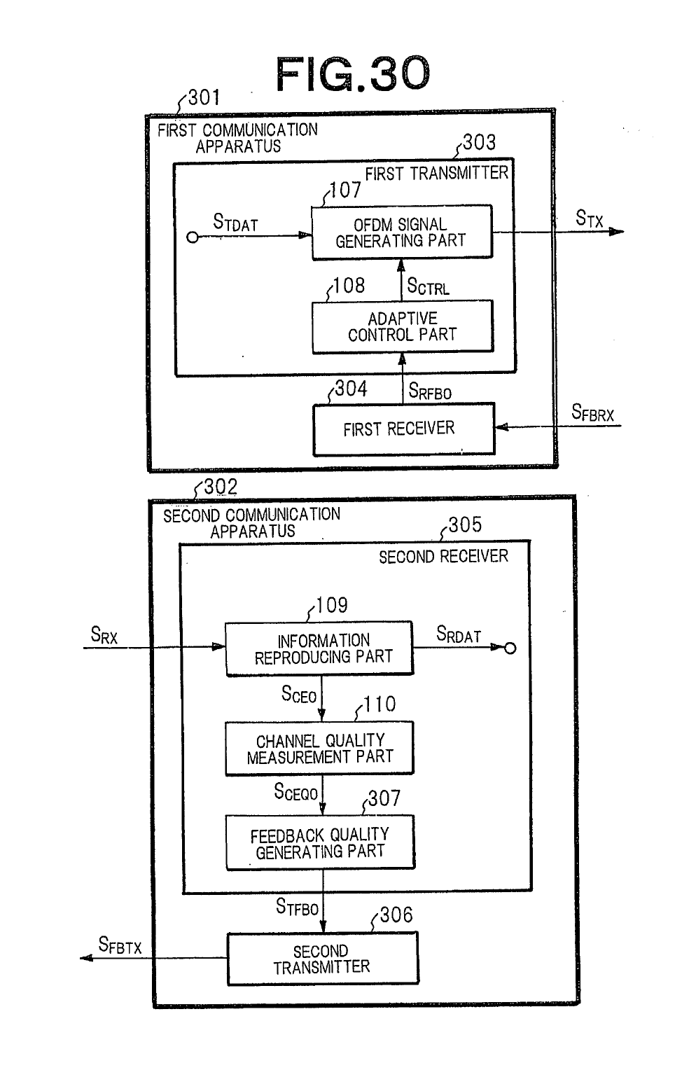

The feedback frequency and the feedback information amount at a time can be adaptively set. Therefore, in the second OFDM block as shown in FIG. 29, the numbers n=2 and j=6 of sub-carriers per two-dimensional block, which are determined in the first OFDM block, and the coefficients of the polynomial {C₀, C₁, C₂, C₃}={0.0967, −0.3450, 0.0883, 1.2100}, {0.1183, −0.4350, 0.1867, 1.0400} are fed back in order from the polynomial assigned with the youngest number.

A program recorded on a recording medium may cause a computer to realize at least part of functions which components of the first communication apparatus 201 and the second communication apparatus 202 as described in the above examples have.

Though the examples of the present invention have been described above in detail, the present invention is not limited to the above examples. A person skilled in the art can conceive various modifications and changes within the scope and spirit of the present invention, based on the descriptions of the appended claims. Such modifications and changes shall be considered to be within the scope of the present invention.

### INDUSTRIAL APPLICABILITY

The present invention can realize accurate feedback with suppressing the amount of information with respect to channel states. Accordingly, high quality communication can be achieved effectively utilizing communication bands.

1. An OFDM communication system comprising:
a first communication apparatus including a first transmitter and a first receiver; and
a second communication apparatus including a second transmitter and a second receiver,
wherein:
said first receiver is configured to output reproduced feedback information, based on a received feedback signal corresponding to a transmitted feedback signal sent from said second transmitter;
said first transmitter includes
an adaptive control part configured to output control information based on the reproduced feedback information, and
an OFDM signal generating part configured to generate a transmitted OFDM signal in which one frame is constituted of F OFDM symbols (where F is an integer not smaller than 1) each consisting of N sub-carriers (where N is an integer not smaller than 2), based on information data and the control information;
said second receiver includes
an information reproducing part configured to output reproduced information data corresponding to the information data and channel information, based on a received OFDM signal corresponding to the transmitted OFDM signal sent from said first transmitter,
a channel quality measurement part configured to measure channel quality, based on the channel information, and outputs a measurement result thereof as channel quality information, and
a feedback control part configured to output, as feedback information, information concerning channel quality obtained by considering variation of the channel quality in two-dimensional fields of a time domain and a frequency domain, based on the channel quality information, and by adaptively controlling resolutions in the time domain and the frequency domain; and
said second transmitter is configured to output the transmitted feedback signal, based on the feedback information.

2. The OFDM communication system according to claim 1, wherein said feedback control part includes:
a time variation measurement part configured to measure variation of the channel quality in the time domain, based on the channel quality information, and to output a measurement result thereof as time variation information;
a frequency variation measurement part configured to measure variation of the channel quality in the frequency domain, based on the channel quality information, and to output a measurement result thereof as frequency variation information; and
a feedback information generating part configured to output the feedback information, based on the channel quality information, the time variation information, and the frequency variation information.

3. The OFDM communication system according to claim 2, wherein:
said feedback information generating part includes:
a two-dimensional control part configured to set the numbers n and j of sub-carriers per two-dimensional block respectively in the time domain and the frequency domain, in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and the frequency variation information, and to output the numbers n and j of sub-carriers, as two-dimensional control information; and
a feedback quality generating part configured to measure channel quality in each of total L two-dimensional blocks (where L=K×M, K=J/j, and M=N/n), based on the channel quality information and the two-dimensional control information, and to output a measurement result thereof as feedback quality information; and
said feedback information generating part is configured to output the two-dimensional control information and the feedback quality information, as the feedback information.

4. The OFDM communication system according to claim 2, wherein:
said feedback information generating part includes:
a two-dimensional control part configured to set the numbers n and j of sub-carriers per two-dimensional block respectively in the time domain and the frequency domain (where j and n are respectively divisors of J and N, and are multiplied by each other to give a constant product i.e. j×n=P, and J=F×G is given), under a condition that a total number L of two-dimensional blocks (where L is a divisor of Q and Q=N×J is given) and a number P of sub-carriers per two-dimensional block (where P=Q/L) are maintained constant, in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and the frequency variation information, and to output the numbers n and j of sub-carriers, as two-dimensional control information; and
a feedback quality generating part configured to measure channel quality in each of total L two-dimensional blocks, based on the channel quality information and the two-dimensional control information, and to output a measurement result thereof as feedback quality information; and
said feedback information generating part is configured to output the two-dimensional control information and the feedback quality information, as the feedback information.

5. The OFDM communication system according to claim 2, wherein:
said time variation measurement part is configured to measure an amount of variation of channel quality between adjacent sub-carriers in the time domain, and to output a measurement result thereof as the time variation information; and
said frequency variation measurement part is configured to measure a variation amount of channel quality between adjacent sub-carriers in the frequency domain, and to output a measurement result thereof as the frequency variation information.

6. The OFDM communication system according to claim 2, wherein:
said time variation measurement part is configured to measure variance of channel quality in the time domain, and to output a measurement result thereof as the time variation information; and
said frequency variation measurement part is configured to measure variance of channel quality in the frequency domain, and to output a measurement result thereof as the frequency variation information.

7. The OFDM communication system according to claim 3, wherein
said two-dimensional control part is configured to set the number j of sub-carriers per two-dimensional block in the time domain in inverse proportion to the time variation information, and to set the number n of sub-carriers per two-dimensional block in the frequency domain in inverse proportion to the frequency variation information.

8. The OFDM communication system according to claim 3, wherein
said feedback quality generating part is configured to average channel quality of total P sub-carriers in each of the L two-dimensional blocks, and to output an averaged result as the feedback quality information.

9. The OFDM communication system according to claim 3, wherein
said two-dimensional control part is configured to:
determine variation of the channel quality in the two-dimensional fields of the time domain and the frequency domain, in arbitrary time equivalent to X frames (where X is a natural number);
determine an OFDM block length based on the time variation information, thereafter performs two-dimensional blocking based on the time variation information and the frequency variation information; and
output the two-dimensional control information.

10. The OFDM communication system according to claim 3, wherein
said feedback quality generating part is configured to output the feedback quality information, based on the two-dimensional control information generated in previously transmitted B OFDM blocks (where B is a natural number).

11. The OFDM communication system according to claim 3, wherein
said two-dimensional control part is configured to:
sequentially determine variation of channel quality in the two-dimensional fields of the time domain and the frequency domain, in units of arbitrary time in one OFDM block;
perform two-dimensional blocking based on the time variation information and the frequency variation information; and
output the two-dimensional control information.

12. The OFDM communication system according to claim 4, wherein
said feedback quality generating part is configured to, under a condition that an amount of all feedback information is maintained constant in each one OFDM block, generate the feedback quality information by adaptively controlling an amount of feedback information fed back at a time and a feedback frequency indicating the number of times by which feedback is carried out in the time domain in one OFDM block unit.

13. The OFDM communication system according to claim 4, wherein
said feedback quality generating part is configured to generate the feedback quality information under a condition that an amount of feedback information fed back at a time and a feedback frequency indicating the number of times by which feedback is carried out in the time domain in one OFDM block unit are maintained constant.

14. The OFDM communication system according to claim 13, wherein
said feedback quality generating part is configured to generate the feedback quality information by time-dividing channel quality of each L/K two-dimensional blocks into feedback information equivalent to Kmax/K times, in OFDM symbols from ((i−1)×j+1)-th OFDM symbol to (i×j)-th OFDM symbol (where i=1, 2, 3, . . . , K), so that the feedback frequency in each OFDM block is maintained at a maximum value Kmax of K (where Kmax=J/jmin: Jmin is an arbitrary minimum value of j) and so that the amount of feedback information fed back at a time is maintained at channel quality equivalent to L/Kmax two-dimensional blocks.

15. The OFDM communication system according to claim 2, wherein:
said feedback information generating part includes:
a two-dimensional control part configured to set the numbers n and j of sub-carriers per two-dimensional block respectively in the time domain and the frequency domain (where j and n are respectively divisors of J and N and are multiplied by each other to give a constant product (j×n=P), and J=F×G is given), under a condition that a total number L of two-dimensional blocks (where L is a divisor of Q and Q=N×J is given) and a number P of sub-carriers per two-dimensional block (where P=Q/L) are maintained constant, in two-dimensional blocking of dividing one OFDM block constituted of G frames (where G is an integer not smaller than 1), into two-dimensional blocks each constituted of plural sub-carriers adjacent to each other in the time domain and in the frequency domain, based on the time variation information and the frequency variation information, and to output the numbers n and j of sub-carriers, as two-dimensional control information; and
a polynomial approximation part configured to approximate variation of channel quality to a polynomial, based on the channel quality information and the two-dimensional control information, and outputs coefficients of the polynomial, inflection points thereof, and channel quality at the inflection points, or only the coefficients, as feedback quality information; and
said feedback information generating part is configured to output the two-dimensional control information and the feedback quality information, as the feedback information.

16. The OFDM communication system according to claim 15, wherein
said polynomial approximation part is configured to approximate variation of channel quality in either the time domain or the frequency domain in each of L two-dimensional blocks to one polynomial, and
if the variation of channel quality in the time domain is approximated to a polynomial, a t-th sub-carrier (where t is an arbitrary integer between 1 to n) among sub-carriers which belong to each of j OFDM symbols is selected from every T-th OFDM symbol in order from a first OFDM symbol (where T is an arbitrary integer between 0 and j−2), and variation of channel quality throughout the selected sub-carriers is approximated to one polynomial, or
if the variation of channel quality in the frequency domain is approximated to a polynomial, every S-th sub-carrier (where S is an arbitrary integer between 0 and n−2) is selected in order from a first sub-carrier among sub-carriers which belong to an s-th OFDM symbol (where s is an arbitrary integer between 1 to j), and variation of channel quality throughout the selected sub-carriers is approximated to one polynomial.

17. The OFDM communication system according to claim 15, wherein
said polynomial approximation part is configured to:
average channel quality of total P sub-carriers in each of L two-dimensional blocks,
approximate variation of channel quality throughout every adjacent K two-dimensional blocks in the time domain to u polynomials (where u is an arbitrary integer between 0 and K−1), and
approximate variation of channel quality throughout every adjacent M two-dimensional blocks in the frequency domain to v polynomials (where v is an arbitrary integer between 0 and M−1).

18. The OFDM communication system according to claim 15, wherein
said polynomial approximation part is configured to arbitrarily preset a maximum number w of polynomials to be approximated to (where w=u×M+v×K).

19. The OFDM communication system according to claim 15, wherein
said polynomial approximation part is configured to arbitrarily preset a maximum order of polynomials to be approximated to.

20. The OFDM communication system according to claim 15, wherein
said polynomial approximation part is configured to approximate variation of channel quality according to a least squares method or Lagrange interpolation method.

21. The OFDM communication system according to claim 1, wherein
said channel quality measurement part is configured to use, as channel quality, a SIR (Signal-to-Interference Ratio: ratio between desired signal power and interference signal power) or a channel gain.

22. A feedback information generation method for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the method comprising:
a step of measuring variation of channel quality in each of sub-carriers constituting the received OFDM signal;
a step of measuring variation of channel quality in each of a time domain and a frequency domain, based on the measured channel quality; and
a step of generating the feedback information, based on the measured variation of channel quality in each of the time domain and the frequency domain.

23. The feedback information generation method according to claim 22, wherein
said step of generating the feedback information includes:
a step of dividing one OFDM block constituted of G frames (where G is an integer not smaller than 1), into two-dimensional blocks each constituted of plural sub-carriers adjacent to each other in each of the time domain and the frequency domain, based on the measured variation of channel quality in each of the time domain and the frequency domain; and
a step of generating the feedback information, based on two-dimensional control information, which indicates the number of sub-carriers per two-dimensional block in each of the time domain and the frequency domain, and the channel quality information.

24. The feedback information generation method according to claim 22, wherein
said step of generating the feedback information includes:
a step of dividing one OFDM block constituted of G frames (where G is an integer not smaller than 1), into two-dimensional blocks each constituted of plural sub-carriers adjacent to each other in each of the time domain and the frequency domain, based on the measured variation of channel quality in each of the time domain and the frequency domain; and
a step of outputting channel quality per two-dimensional block and two-dimensional control information, as the feedback information, based on the channel quality information and the two-dimensional control information which indicates the number of sub-carriers per two-dimensional block in each of the time domain and the frequency domain.

25. The feedback information generation method according to claim 22, wherein
said step of generating the feedback information includes:
a step of dividing one OFDM block constituted of G frames (where G is an integer not smaller than 1), into two-dimensional blocks each constituted of plural sub-carriers adjacent to each other in each of the time domain and the frequency domain, based on the measured variation of channel quality in each of the time domain and the frequency domain; and
a step of approximating variation of channel quality throughout plural adjacent two-dimensional blocks to a polynomial, based on the channel quality information and two-dimensional control information which indicates the number of sub-carriers per two-dimensional block in each of the time domain and the frequency domain, taking coefficients of the polynomial, inflection points thereof, and channel quality at the inflection points, or only the coefficients, as feedback quality information, and outputting the feedback quality information and the two-dimensional control information, as feedback information.

26. A feedback information generation program for a communication apparatus for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the program causing a computer to execute:
a process of measuring variation of channel quality in each of the time domain and the frequency domain, using channel quality information which indicates channel quality of each of sub-carriers constituting the received OFDM signal; and
a process of generating the feedback information, using a result of measuring variation of channel quality in each of the time domain and the frequency domain.

27. The feedback information generation program according to claim 26, wherein
said process of generating the feedback information includes:
a process of performing two-dimensional blocking for dividing one OFDM block constituted of G frames (where G is an integer not smaller than 1), into two-dimensional blocks each constituted of plural sub-carriers adjacent to each other in each of the time domain and the frequency domain, using a result of measuring variation of channel quality in each of the time domain and the frequency domain; and
a process of generating the feedback information, based on two-dimensional control information, which indicates the number of sub-carriers per two-dimensional block in each of the time domain and the frequency domain, and the channel quality information.

28. The feedback information generation program according to claim 26, wherein
said process of generating the feedback information includes:
a process of performing two-dimensional blocking for dividing one OFDM block constituted of G frames (where G is an integer not smaller than 1), into two-dimensional blocks each constituted of plural sub-carriers adjacent to each other in each of the time domain and the frequency domain, using a result of measuring variation of channel quality in each of the time domain and the frequency domain; and
a process of outputting channel quality per two-dimensional block and two-dimensional control information, as the feedback information, based on the channel quality information and the two-dimensional control information which indicates the number of sub-carriers per two-dimensional block in each of the time domain and the frequency domain.

29. The feedback information generation program according to claim 26, wherein
said process of generating the feedback information includes:
a process of performing two-dimensional blocking for dividing one OFDM block constituted of G frames (where G is an integer not smaller than 1), into two-dimensional blocks each constituted of plural sub-carriers adjacent to each other in each of the time domain and the frequency domain, using a result of measuring variation of channel quality in each of the time domain and the frequency domain; and
a process of approximating variation of channel quality throughout plural adjacent two-dimensional blocks to a polynomial, based on the channel quality information and two-dimensional control information which indicates the number of sub-carriers per two-dimensional block in each of the time domain and the frequency domain, taking coefficients of the polynomial, inflection points thereof, and channel quality at the inflection points, or only the coefficients, as feedback quality information, and outputting the feedback quality information and the two-dimensional control information, as feedback information.

30. A communication apparatus for receiving an OFDM signal in which one frame is constituted of F OFDM symbols (where F is an integer not smaller than 1) each constituted of N sub-carriers (where N is an integer not smaller than 2), and for generating feedback information based on the received OFDM signal, the apparatus comprising:
first measurement means for measuring variation of channel quality in each of sub-carriers constituting the received OFDM signal;
second measurement means for measuring variation of channel quality in each of a time domain and a frequency domain, based on the channel quality measured by the first measurement means; and
feedback information generation means for generating the feedback information, based on the variation of channel quality in each of the time domain and the frequency domain, which is measured by the second measurement means.

31. The communication apparatus according to claim 30, wherein
said feedback information generation means includes:
means for dividing one OFDM block constituted of G frames (where G is an integer not smaller than 1), into two-dimensional blocks each constituted of plural sub-carriers adjacent to each other in each of the time domain and the frequency domain, based on the variation of channel quality in each of the time domain and the frequency domain, which is measured by the first measurement means; and
means for generating the feedback information, based on two-dimensional control information, which indicates the number of sub-carriers per two-dimensional block in each of the time domain and the frequency domain, and the channel quality information.

32. The communication apparatus according to claim 30, wherein
said feedback information generation means includes:
means for dividing one OFDM block constituted of G frames (where G is an integer not smaller than 1), into two-dimensional blocks each constituted of plural sub-carriers adjacent to each other in each of the time domain and the frequency domain, based on the variation of channel quality in each of the time domain and the frequency domain, which is measured by the first measurement means; and
a step of outputting channel quality per two-dimensional block and two-dimensional control information, as the feedback information, based on the channel quality information and the two-dimensional control information which indicates the number of sub-carriers per two-dimensional block in each of the time domain and the frequency domain.

33. The communication apparatus according to claim 30, wherein
said feedback information generation means includes:
means for dividing one OFDM block constituted of G frames (where G is an integer not smaller than 1), into two-dimensional blocks each constituted of plural sub-carriers adjacent to each other in each of the time domain and the frequency domain, based on the variation of channel quality in each of the time domain and the frequency domain, which is measured by the first measurement means; and
means for approximating variation of channel quality throughout plural adjacent two-dimensional blocks to a polynomial, based on the channel quality information and two-dimensional control information which indicates the number of sub-carriers per two-dimensional block in each of the time domain and the frequency domain, taking coefficients of the polynomial, inflection points thereof, and channel quality at the inflection points, or only the coefficients, as feedback quality information, and outputting the feedback quality information and the two-dimensional control information, as feedback information.
